(19) United States
(12) Patent Application Publication
(10) Pub. No.: US 2003/0195807 A1
(43) Pub. Date: Oct. 16, 2003

(54) Method and system for verifying exposure to message content via a printed response

(75) Inventors: Frank S. Maggio, St. Petersburg, FL (US); Mark Allen Siler, St. Petersburg, FL (US)

Correspondence Address: KING & SPALDING, 191 PEACHTREE STREET, N.E., ATLANTA, GA, 30303-1763, US

(73) Assignee: Frank S. Maggio, St. Petersburg, FL

(21) Appl. No.: 10/434,622

(22) Filed: May 9, 2003

Related U.S. Application Data
(63) Continuation-in-part of application No. 09/820,482, filed on Mar. 29, 2001, now Pat. No. 6,606,745.
(60) Provisional application No. 60/239,631, filed on Oct. 12, 2000.
(60) Provisional application No. 60/379,799, filed on May 10, 2002.

(51) Int. Cl. G06F 17/60

(52) U.S. Cl. 705/14

(57) ABSTRACT

Providing advertising comprises communicating, through a mass media, non-interactive broadcast network, an advertisement pod comprising multiple advertisements to a plurality of recipients. Each advertisement comprises advertising content. A query is communicated to the recipients about a selected portion of the advertising content of at least one of the advertisements. An offer of a reward is presented to the recipients as an incentive for each recipient to review the advertisements and to submit the response to the query. Respective responses to the query are collected through a printed response from each of responding ones of the recipients. Receipt of each response having a correct reply to the query verifies that the responding recipient has been exposed to at least the selected portion of the advertising content.

### RELATED APPLICATIONS

This application is a continuation-in-part of allowed U.S. patent application Ser. No. 09/820,482, filed Mar. 29, 2001 and entitled “Method and System for Communicating Advertising and Entertainment Content and Gathering Consumer Information,” which claims priority under 35 U.S.C. § 119 to U.S. Provisional Patent Application No. 60/239,631, filed Oct. 12, 2000 and entitled “System and Method for Using Linked Sponsorships to Increase Mass-Market Appeal of Content.” Additionally, this application claims priority under 35 U.S.C. § 119 to U.S. Provisional Patent Application No. 60/379,799, filed May 10, 2002 and entitled “Methods and Systems of Utilizing Response Cards and Other Printed Items as Response Devices in the CR\overline{A}V Immersion Verification and Registration System and Process.” The complete disclosure of each of those priority documents is hereby fully incorporated herein by reference.

### FIELD OF THE INVENTION

The present invention relates to techniques for communicating content, and more particularly to techniques for communicating advertising content and entertainment content. Specifically, the present invention relates to verifying content immersion via a printed response.

### BACKGROUND OF THE INVENTION

In the traditional advertising model, media (e.g., TV networks, radio stations, newspapers, magazines) develop entertainment content (e.g., a TV show) of interest to Consumers. The Consumers are persons who may use an Advertisers commodity or service, and who view, hear, read, or otherwise absorb the entertainment content, as well as advertising content (“ads”). The Advertisers are entities that distribute the ads to induce the Consumers to buy, use, or do something. The media delivers the entertainment content and the ads to the Consumers (e.g., over the air, by cable transmission, by print media mass distribution). Media may charge the Consumers for the entertainment content delivery, but typically media receives most revenue from the Advertisers in exchange for delivering ads with the entertainment content.

Promoters initiate, develop, generate, and/or distribute entertainment content, attracting many of the Consumers and, in turn, attracting the Advertisers. The Advertisers sponsor the entertainment content by paying the Promoters to deliver the ads with the entertainment content. Advertising fees generally increase as the number of the Consumers absorbing the ads increases. The Promoters use the advertising fees to offset the Promoters' costs to produce and distribute the advertising content and to make a profit. The Consumers usually do not pay to see, hear, or otherwise absorb the entertainment content. The Consumers also do not receive payment for seeing, hearing, or otherwise absorbing the ads. The Consumers' traditional reward is the ability to see, hear, or otherwise absorb and enjoy the entertainment content for little or no charge, in exchange for tolerating the ads.

Recent technological advancements (i.e., the Internet) have caused an increase in possible broadcast outlets. With this increase, the Consumers are distracted by multiple entertainment forms. As a result, the Advertisers have more difficulty reaching mass numbers of the Consumers. In addition, the Promoters have more difficulty guaranteeing many of the Consumers will watch, hear, or otherwise absorb the entertainment content and the ads. This phenomena has led to lower advertising fees and thus lower profitability to the Promoters.

The Advertisers' goal is to provide the Consumers with ads they will remember that include information on the Advertisers' product or service. However, the Consumers typically ignore and avoid the ads. The Consumers often “tune out,” change the channel, or walk away when the ads appear. In addition, the Consumers increasingly turn to less advertising-dependent entertainment forms (e.g., premium channels), or use technology (e.g., video recorders, personal recording devices) to skip the ads.

Advertising can be divided into two classes: mass media advertising and targeted advertising. Mass media advertising (e.g., over a broadcast network such as TV, radio, newspaper, magazine, mass mail, mass e-mail, etc.) sends broadly based advertising messages to a wide spectrum of the Consumers. Targeted advertising focuses on delivering specific, personalized advertising to the Consumers that meet a demographic profile specified by the Advertisers. Mass media advertising is usually less expensive per impression than targeted advertising. However, targeted advertising is usually more effective and has become less expensive per impression as technology has progressed. As a result, the effectiveness of mass media advertising has been questioned.

In view of the foregoing, there is a need for a cost-effective, entertaining, rewarding, and effective way of mass media advertising. A need also exists for verifying consumer immersion in the mass media advertising. In addition, there is a need for a cost-effective way to gather information useful to the Advertisers.

### SUMMARY OF THE INVENTION

The present invention solves the above problems by providing a cost-effective, entertaining, rewarding, and effective way to present entertainment content and ads to a mass audience. For example, the present invention may transform advertising from something Consumers avoid to a drawing card that attracts the Consumers. The Consumers can be presented with an opportunity to remember ads and to win valuable prizes. This may increase viewership, consumer entertainment, and advertising immersion.

The present invention may communicate Consumer Rewarded Advertising Vehicle Immersive Ad Bundles (“CR\overline{A}V Ads”). The CR\overline{A}V Ads may be an ad including an Advertising Vignette (“Vignette”) and a Verification Query (“Query”). An optional Immersion Alert (“Alert”) may also be added. In addition, an optional Correct Answer (“Answer”) may be added. The CR\overline{A}V Ads may be any duration. The CR\overline{A}V Ads may be visual and/or audible. The CR\overline{A}V Ads may be spoken, printed, displayed, heard, or communicated by any possible means, or any combination of possible means. The CR\overline{A}V Ad, or a series of CR\overline{A}V Ads, may also be the basis for an entire show, particularly of the game show genre.

Another option, called a “Sneak Peek” Vignette, may be used to promote the CR\overline{A}V Ads. The Sneak Peek Vignette may be identical to the CR\overline{A}V Ad Vignette. The Sneak Peek Vignette may also contain other information that helps the Consumers answer the Query.

The present invention can comprise a Broadcast Network, the Consumers, a Response Device, an Information Gathering System, and a Data Storage Center. The Consumers, Advertisers, Promoters, or other entities, can use the present invention. The Consumers can be persons who may use the Advertiser's commodity or service, who view, hear, read, or otherwise absorb the entertainment content and the ads. The Advertisers can be entities that distribute the ads to induce the Consumers to buy, use, or do something. The Promoters can initiate, develop, generate, and/or distribute entertainment content attracting many of the Consumers, and will in turn attract the Advertisers. While the invention has been discussed in the context of the Consumers, the Promoters, and the Advertisers, those experienced in the art will recognize that other entities can be used.

The Broadcast Network can be a means of connecting the Consumers with the entertainment content and the ads. The Device can be a means of communicating the consumer information to the Information Gathering System. The Information Gathering System can be a means of forwarding the information to the Data Storage Center. The Data Storage Center can be a means for storing and using the consumer information. The consumer information can include registration and response information. The registration information can include personal information, such as name, address, phone number, household income, maximum education, etc. The response information can include answers to the Query questions.

The Promoters can sell the CR\overline{A}V Ads to the Advertisers. The Promoters or the Advertisers can use the Broadcast Network to promote future CR\overline{A}V Ads. The Promoters can use the Broadcast Network, the Device, the Information Gathering System, and the Data Storage Center to communicate the CR\overline{A}V Ads to the Consumers and to interact with the Consumers. The Promoters or the Advertisers can use the Device, the Information Gathering System, and the Data Storage Center to gather the Consumers' responses to the CR\overline{A}V Ads. The Promoters can edit and/or distribute the registration and response information to the Advertiser or other interested third parties. The Promoters can select the winners and distribute the prizes.

A privacy option can be included to implement privacy protection for the Consumers that respond to the CR\overline{A}V Ads, who have provided personal and confidential data while registering. This option helps ensure security, data protection, and isolation levels.

In one aspect of a CR\overline{A}V advertisement, elements of a CR\overline{A}V ad can be included on a printed response device itself, in effect converting the printed response to a self-contained, printed CR\overline{A}V ad, complete with the “Alert,” printed “Vignette,” and Immersion Verification Query (or an area upon the printed response to enter the response, after broadcast of the Immersion Verification Query via another medium, such as Television or Internet).

### BRIEF DESCRIPTION OF THE DRAWINGS

FIG. 1 is a block diagram illustrating the primary components of an exemplary embodiment of the present invention.

FIG. 2 is a flow diagram illustrating an overview of an exemplary CR\overline{A}V Ad process.

FIG. 3 is a flow diagram illustrating an exemplary process describing how the Promoters sell the CR\overline{A}V Ads to the Advertisers.

FIG. 4 is a flow diagram illustrating an exemplary process describing how the Promoters and the Advertisers use the Broadcast Network to promote future CR\overline{A}V Ads.

FIG. 5 is a flow diagram illustrating an exemplary process describing how the privacy option applies to the invention.

FIG. 6 is a flow diagram illustrating an exemplary process describing how the Promoters use the Broadcast Network, the Device, the Information Gathering System, and the Data Storage Center to communicate the CR\overline{A}V Ads to the Consumers and to interact with the Consumers.

FIG. 7 is a flow diagram illustrating an exemplary process describing how the Promoter communicates the Alert, the Vignette, and the Query using the Broadcast Network.

FIG. 8 is a flow diagram illustrating an exemplary process describing how the Consumers answer the CR\overline{A}V Ads.

FIGS. 9A and 9B, together comprising FIG. 9, are picture diagrams illustrating an exemplary nationwide network for gathering CR\overline{A}V Ad responses.

FIG. 10 is a picture diagram illustrating how the Information Gathering System sends the registration and the response information to the Data Storage Center in an exemplary embodiment.

FIG. 11 is a flow diagram illustrating an exemplary process describing how the Promoters select winners and distribute prizes.

FIG. 12 is a flow diagram illustrating an exemplary process describing an overview of a CR\overline{A}V Ad process.

FIG. 13 is a flow diagram illustrating an exemplary process describing how the ad slots are sold.

FIG. 14 is a chart illustrating how the ad price is determined in an exemplary embodiment.

FIG. 15 is a picture flow diagram illustrating an exemplary CR\overline{A}V Ad process for ABS and ACME to promote future CR\overline{A}V Ads.

FIG. 16 is a chart illustrating a CR\overline{A}V record in an exemplary embodiment.

FIG. 17 is a flow chart illustrating how ABS broadcasts the CR\overline{A}V Ads in an exemplary embodiment.

FIG. 18 illustrates the CR\overline{A}V Ad the Consumers see in an exemplary embodiment.

FIG. 19 is a flow diagram illustrating how the CR\overline{A}V Ads are answered by the customers in an exemplary embodiment.

FIG. 20 is a flow diagram illustrating how the CR\overline{A}V Ads are answered by the Dalys in an exemplary embodiment.

FIG. 21 illustrates a representative OMR printed response according to an exemplary embodiment of the present invention.

FIG. 22 illustrates a representative OCR printed response according to an exemplary embodiment of the present invention.

FIG. 23 illustrates a representative manual data entry printed response according to an exemplary embodiment of the present invention.

FIG. 24 illustrates a representative multiple-entry printed response according to an exemplary embodiment of the present invention.

FIG. 25 is a flow chart depicting a method for providing an advertisement that combines CR\overline{A}V ad elements with the interactive portion of a reply according to an exemplary embodiment of the present invention.

### DETAILED DESCRIPTION OF THE EXEMPLARY EMBODIMENTS

The present invention solves the above problems by providing a cost-effective, entertaining, rewarding, and effective way to present ads to an audience. For example, the present invention transforms advertising from something Consumers avoid to a drawing card that attracts the Consumers. The Consumers are presented with an opportunity to win valuable prizes. This opportunity increases viewership, consumer entertainment, and advertising immersion.

The present invention may be used by Promoters to increase an ad's appeal, while substantially and cost-effectively enhancing an Advertiser's promotion and retention of its products and services. When compared to traditional mass media advertising, an exemplary embodiment delivers ads that cause the Consumers to fully immerse themselves in the ad. An exemplary embodiment can deliver ads in print, by radio, by TV, as a game show, or by any other method that communicates with the Consumers.

Immersion is a heightened attention level that causes the Consumers to remember the ads. Immersion is the highest, most effective, and valuable attention level. Immersion helps the Advertisers achieve a maximized share of the Consumers' mind for their product. Products are remembered easier and faster than competing products.

Immersion is enhanced by several methods. First, immersion is enhanced when the ad triggers an immediate emotional response within the brain, such as a warning or alert signal. This signal causes the Consumers to pay more attention to the ads, and increases the likelihood the Consumers will remember the ads. When the Consumers interact with the ads, as opposed to passively viewing or hearing the ads, the Consumers are more likely to remember the ads. A memorization request also increases immersion by testing the Consumers ability to recall the ads. In addition, extended exposure, which is obtained by a longer effective ad length, increases the likelihood of immersion. Effective length begins from the first moment one recognizes the brand advertised. Another advertising technique that increases immersion is using alternate, multiple media vehicles for distributing advertising (i.e., using print or Internet-based advertising simultaneously, or following, TV advertising). Rewards also help to create immersion because the Consumers like challenges and rewards, and likable ads are more readily and easily recalled.

CR\overline{A}V Ad Description

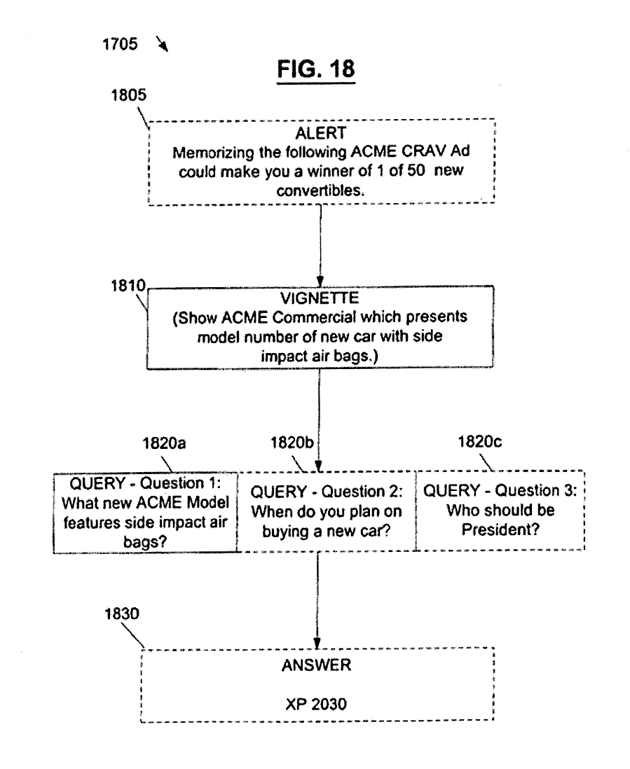

Consumer Rewarded Advertising Vehicle Immersive Ad Bundles (“CR\overline{A}V Ads”) provide a process for Promoters to increase viewership and immersion. A CR\overline{A}V Ad example will be discussed while referring to FIG. 18 later in this document. However, for purpose of defining the CR\overline{A}V Ad, it is useful to refer to FIG. 18 at this time.

Turning now to FIG. 18, an exemplary CR\overline{A}V Ad is displayed. The CR\overline{A}V Ad is an ad including at least an Advertising Vignette (“Vignette”) 1810 and a Verification Query (“Query”) 1820. An Immersion Alert (“Alert”) 1805 can also be included. In addition, an optional Correct Answer (“Answer”) 1830 may be added. These parts create a CR\overline{A}V Ad that may be any duration. The CR\overline{A}V Ad may be visual and/or audible. The CR\overline{A}V Ad may be spoken, printed, displayed, heard, or communicated by any other possible means, or any combination of possible means. A CR\overline{A}V Ad, or a series of CR\overline{A}V Ads, may also be the basis for an entire show.

Some or all of the components of the Query 1820 may be “detached” from the Vignette 1810 (i.e., the Vignette 1810 may be in print and the Query 1820 may be posted on-line or by phone). In addition, the response time for the Query 1820 may be limited to cause the Consumers to memorize the Vignette 1810 for expedited recall (from memory) when asked the Query 1820. Similarly, the Alert 1805 and/or the Answer 1830 may be detached from the Vignette 1810 and/or the Query 1820. Accordingly, the Vignette, Query, Alert, and offer of a reward can be communicated via the same communications media or different communications media. The communications media can comprise a broadcast network 105 or a response device 111.

The Alert 1805, which is optional (as indicated by the dashed lines), is a warning to the Consumers that the upcoming Vignette 1810 should be memorized so the Consumers may become eligible to win a reward. The Alert 1805 could be any cue or operational procedure that leads the Consumers to believe that immersion may lead to a reward. The Alert 1805 may be as simple as a logo (such as a CR\overline{A}V logo), a sound, or some other discrete notice. The Alert 1805 may also include much more extensive data. The Alert 1805 may include the product's brand name and information on the identity of the available rewards. By providing branding during the Alert 1805, the Advertisers effectively begin the CR\overline{A}V Ad's exposure time. The Alert 1805 is an urgency signal and a memorization request. These advertising techniques increase the likelihood of the Consumer remembering the ad. The Alert 1805 may be any duration.

Following the Alert 1805, a Vignette 1810 is broadcast. The Vignette 1810 may be a conventional commercial for a product or service or any other information designed for presentation to a consuming audience. This may include key product or service benefits, pricing information, image building information, etc. The Vignette 1810 may be any duration.

Following the Vignette 1810 broadcast, the Query 1820 is broadcast. The Query 1820 includes one or more questions. One question may be linked to the Vignette 1810. This question is designed to require the Consumers to remember certain information. The other questions may ask for public opinion, trivia, or other information, and these questions may be asked on-line or off-line. The Query 1820 questions may be displayed on a separate screen following the Vignette 1810, asked by a crawl-line below the entertainment content, or shown in an alternative way, such as off-line. The Query 1820 may serve to increase the effective length of the CR\overline{A}V Ad, even though the traditional ad (i.e., video or audio clip) extends for a conventional duration, because the Consumers must continue concentrating on the product as advertised during the immersion verification and query response process. During the Query 1820, the Promoters or the Advertisers may provide potential multiple choice answers or require the Consumers to provide the answer without the aid of multiple choice answers. The Query 1820 includes one or more questions and may include reward information, registration or login instructions, multiple choice answers, a “time remaining” counter, and brand information. The CR\overline{A}V Ad may end following the Query 1820.

The Answer 1830, may be added and is optional, as shown by the dashed lines in the Answer 1830. The Answer 1830 extends the CR\overline{A}V Ad's effective length. The Answer 1830 includes the answer or answers to the Query's 1820 one or more questions, where applicable. The Answer 1830 also may include logo or other information. The Answer 1830 may be broadcast via a TV medium, or distributed by an alternate communications medium (e.g., radio, print, Phone 145, Internet 130).

Another option, called the “Sneak Peek” Vignette, may be incorporated. The Sneak Peek may be identical to the CR\overline{A}V Ad Vignette 1810. The Sneak Peek may also contain other information to help the Consumers answer the Query 1820. The Sneak Peek is not shown during the actual CR\overline{A}V Ad, but is shown prior to the CR\overline{A}V Ad. The Sneak Peek may be featured several minutes, hours, days, weeks, etc. before the CR\overline{A}V Ad. The Sneak Peek Vignette may be indicated by a logo, sound, or another method. Alternatively, the Consumers may be informed only that the Sneak Peek will occur at some point during a particular show. The Consumers are told one or more ads are CR\overline{A}V Ad Sneak Peek Vignettes. The Consumers will then pay greater attention to the particular commercial, or all the possible commercials so they may get additional information to help them answer the CR\overline{A}V Ad Query 1820. For example, a Sneak Peek could read: “1 of the following 6 ads will be featured in a CR\overline{A}V Ad next Sunday. Please pay attention to ALL of them, because we will not tell you at this time which ad is the CR\overline{A}V Ad.” This same process could apply to the Vignettes, in addition to the Sneak Peaks. Thus, for example, during the communication of numerous ads, an Alert in the form of a logo could appear on the corner of the ads, which are in the form of Vignettes. After communicating the Vignettes, one or more Queries with immersion verification questions for one or more of the Vignettes would be shown (i.e., at the bottom of the screen while the entertainment content continues). When the user calls, the user could be required to answer one or more of the shown immersion verification questions.

CR\overline{A}V Ad System

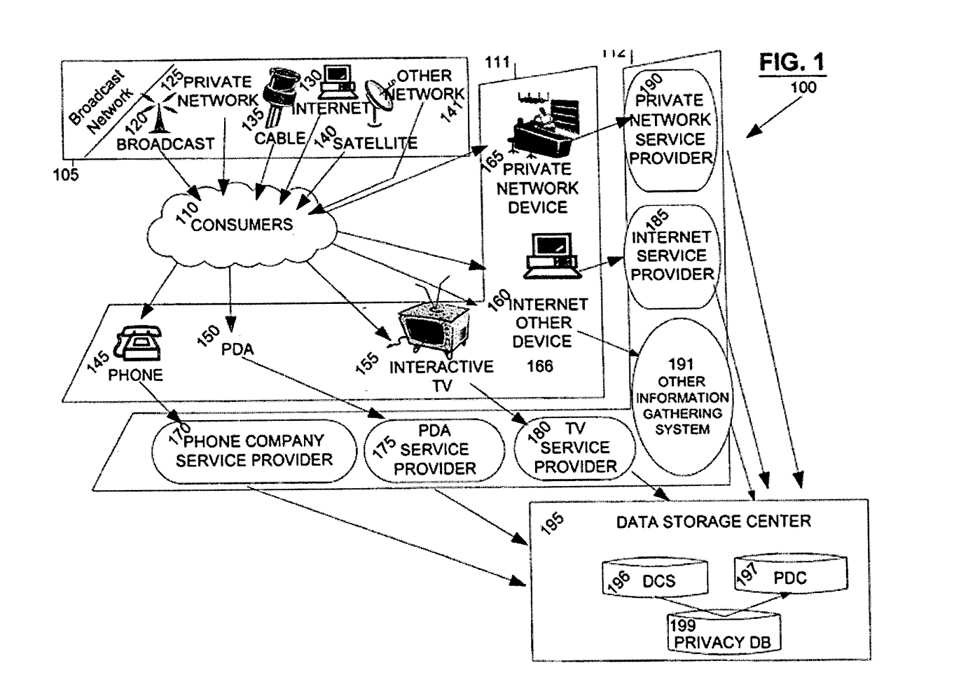

FIG. 1 is a block diagram illustrating the primary components of an exemplary embodiment of the present invention. Turning to FIG. 1, the CR\overline{A}V Ad system 100 includes a Broadcast Network 105, the Consumers 110, an Answering Device (“Device”) 111, an Information Gathering System 112, and a Data Storage Center 195. The Consumers 110, the Advertisers, the Promoters, or other entities, use the present invention. The Consumers 110 are the recipients of the ads and are persons who may use the Advertiser's commodity or service, who view, hear, read, or otherwise absorb the entertainment content and the ads. The Advertisers are entities that distribute the ads to induce the Consumers to buy, use, or do something. The Promoters initiate, develop, generate, and/or distribute entertainment content attracting many of the Consumers, and in turn attracting the Advertisers. While the invention is described in the context of the Consumers, the Advertiser, and the Promoters, those experienced in the art will recognize that other entities can be used.

The Broadcast Network 105 is a means of connecting the Consumers 110 with the entertainment content and the ads. The Device 111 is a means of communicating the registration and the response information to the Information Gathering System 112. The Device 111 also can be a means of communicating with the Consumers 110 by broadcasting an immersion verification question and other questions, and subsequently forwarding related registration and response information to the Information Gathering System 112. The Information Gathering System 112 is a means of forwarding the registration and the response information to the Data Storage Center 195. The Data Storage Center 195 is a means for storing the registration and response information.

The Broadcast Network 105 may include a Broadcast TV Network 120, a Private Network 125, a Cable Network 135, an Internet Network 130, a Satellite Network 140, or any Other Network 141 (e.g., newspaper). Those experienced in the art will recognize numerous communications networks and systems (including presently available systems and future systems) may be substituted or interchanged with the Broadcast Network 105.

The Response Device 111 can comprise a Phone 145, a Personal Digital Assistant (“PDA”) 150, an Interactive TV 155, an Internet Computer 130, a Hospitality Industry Private Network (i.e., a Sports Bar and Pub Device) 165, or any Other Device 166. In an exemplary embodiment, the Other Response Device 166 can comprise a printed response device, which can be completed by a consumer and delivered subsequently to the data storage center 195. For example, the printed response device can comprise a handwritten or typewritten response.

The Devices 111 can include computer-related devices such as cellular phone networks, two-way pagers, and two-way contained network devices such as proprietary NTN systems found in numerous restaurants and pubs throughout the United States. Different instructions and methods may be used to register or answer. Those experienced in the art will recognize numerous devices (including presently available devices and future devices) may be substituted or interchanged as the Device 111. In addition, those experienced in the art will recognize that one Device 111 can be used to register, and another Device 111 used to respond to the CR\overline{A}V Ad.

The Information Gathering System 112 may include numerous service providers (“SPs”), including a Phone Company SP 170, a PDA SP 175, a TV SP 180, an Internet SP 185, a Private Network SP 190, and any other information gathering system 191. For example, the other information gathering system 191 can comprise a private delivery network, such as the U.S. Postal Service, a facsimile machine, or other system. Those experienced in the art will recognize numerous distribution systems (including presently available systems and future systems) may be substituted or interchanged as the Information Gathering System 112.

The Information Gathering System 112 connects to a Data Storage Center 195, which stores data gathered by the Information Gathering System 112. The Data Storage Center 195 may include a Personal Data Center (“PDC”) Database 197 and a Data Compiling and Storage (“DCS”) Center Database 196. The Data Storage Center 195 includes registration information and response information, random winner selection, and long-term storage of data collected for future data mining ventures. The PDC 197 stores the Consumers' personal information, which may include the name, address, social security number (which is typically obtained only from prize winners for tax reporting purposes), personal ID number, phone number, etc. The DCS 196 may store demographic data collected during registration, a CR\overline{A}V ID, and CR\overline{A}V Ad Query 1820 answers.

The Data Storage Center 195 may also include a Privacy Database 199. The Privacy Database 199 is used when the Promoters decide to implement privacy protection for the Consumers 110 that respond to the CR\overline{A}V Ads, who have provided personal and confidential data while registering. The Privacy Database 199 requires records from the PDC 197 and the DCS 196 to match before Consumers' identities are matched with demographic and historical records. This matching helps ensure security, data protection, and isolation levels.

CR\overline{A}V Ad Process Overview

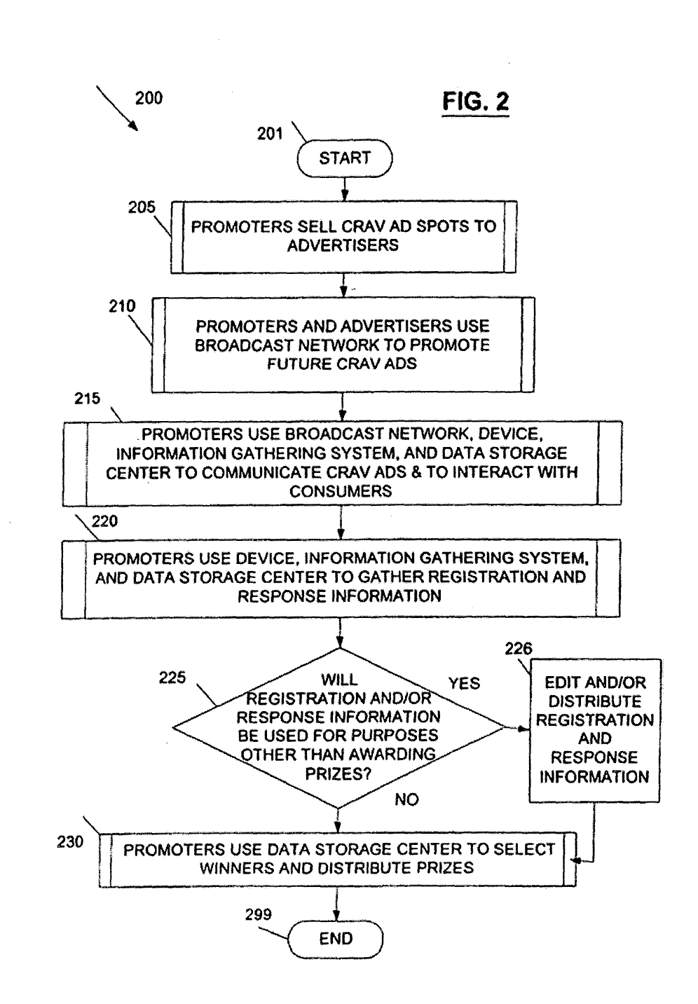

FIG. 2 is a flow diagram illustrating an overview of an exemplary CR\overline{A}V Ad process. Turning now to FIG. 2, an exemplary CR\overline{A}V Ad process 200 is initiated at the “START” step 201. In step 205, the Promoters sell the CR\overline{A}V Ads to the Advertisers. In step 210, the Promoters and the Advertisers use the Broadcast Network 105 to promote future CR\overline{A}V Ads. In step 215, the Promoters use the Broadcast Network 105, the Device 111, the Information Gathering System 112, and the Data Storage Center 195 to communicate the CR\overline{A}V Ads to the Consumers 110 and to interact with the Consumers 110. In step 220, the Promoters use the Device 111, the Information Gathering System 112, and the Data Storage Center 195 to gather the Consumers' registration information and response information. In step 225, it is determined whether or not the registration and/or the response information will be used for purposes other than awarding prizes. If the answer to step 225 is “YES” and the registration and/or the response information will be used, the process moves to step 226, where the Promoters edit and/or distribute the registration and the response information to the Advertisers and other interested entities. If the answer to step 225 is “NO” and the registration and the response information will not be used, the process moves directly to step 230. In step 230, the Promoters use the Data Storage Center to select the winners and distribute the prizes. The process then proceeds to the “END” step 299 and terminates.

CR\overline{A}V Ads Are Sold

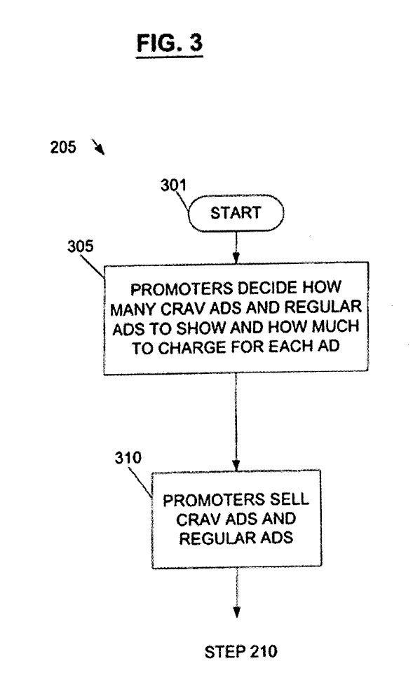

FIG. 3 is a flow diagram illustrating an exemplary process describing how the Promoters sell the CR\overline{A}V Ads to the Advertisers, as set forth in step 205 of FIG. 2. Turning now to FIG. 3, an exemplary CR\overline{A}V Ad process 205 is initiated at the “START” step 301. In step 305, the Promoters decide how many of the CR\overline{A}V Ads and the regular ads to communicate and how much to charge for each ad. In step 310, the Promoters sell the CR\overline{A}V ads and the regular ads. The process then moves to step 210 of FIG. 2.

The CR\overline{A}V Ads may be priced in numerous ways. For example, the price may be dependent on the program's audience size (i.e., ratings), or may be priced based on an auction or bidding process, where the CR\overline{A}V Ads are rewarded to the highest bidder. To establish pricing, the Promoters may analyze the existing program profitability based on standard production, promotion, and broadcast costs. This may be offset by standard advertising fees for standard advertising. The Promoters' CR\overline{A}V Ad price may include the value of a larger audience size and a higher quality of immersion among Consumers 110. This legitimizes a higher cost-per-minute advertising fee, with the additional fee revenues helping to offset CR\overline{A}V Ad reward costs, CR\overline{A}V Ad licensing and promotion costs, and Query 1820 response management process costs.

When determining CR\overline{A}V Ad prices, the following may also be considered: the promotion costs, the simultaneous broadcast venues used, the number and type of immersion rewards, the number of questions in the Query 1820 (i.e., immersion verification question, polling question, trivia-based questions of varied difficulties to reduce the number of fully correct responses), on-air versus off-air immersion verification responses, registration requirements, Query 1820 response gathering methodology, and winner selection and prize awarding responsibility. The Promoters must also determine if the Consumers 110 will be required to answer one or more special Advertiser-designed questions during the immersion verification process. This market data may be very valuable to the Advertisers, and may further substantiate the fee being charged by the Promoters. The Promoters may also elect to add one or more special public opinion questions to the Query 1820. This data may be related to the Promoters' other programs, may determine the Consumers' 110 interest levels to certain programming types, or may address any other marketing related issues. These public opinion questions may also be conducted as a service to public opinion agencies, which may pay the Promoters for providing the public opinion response results.

CR\overline{A}V Ad is Presented to Consumers

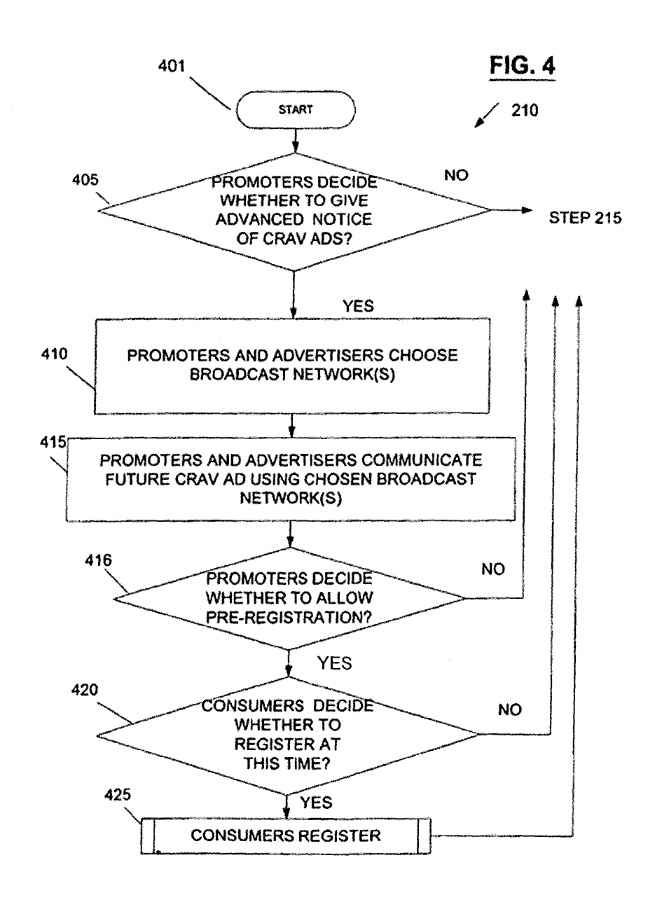

FIG. 4 is a flow diagram illustrating an exemplary process describing how the Promoters and the Advertisers use the Broadcast Network 105 to promote future CR\overline{A}V Ads, as set forth in step 210 of FIG. 2. The public is preferably notified about the broadcast of the CR\overline{A}V Ad to maximize the program's audience size. Prior to the communication including the CR\overline{A}V Ad, the Promoters provide advance warning to the Consumers 110 who may receive programs where the CR\overline{A}V Ads will be communicated. This advanced warning may include educational, general public information informing the Consumers 110 about the CR\overline{A}V Ads, and how successful immersion may result in the Consumers 110 receiving substantial rewards. These advance warnings also may include specific prize information, reveal the name and/or logo, and invite registration by the Consumers 110 prior to the broadcast. The Promoters and the Advertisers may provide this advanced notice.

Turning now to FIG. 4, an exemplary CR\overline{A}V Ad process 210 is initiated at the “START” step 401. In step 405, the Promoters determine whether or not to give advanced notice of the future CR\overline{A}V Ad broadcast. If the answer is “NO,” then the process moves to step 215 of FIG. 2. If the answer is “YES,” the process moves to step 410, where the Promoters and the Advertisers choose the Broadcast Network 105 for the advanced notice. The Broadcast Network 105 that can be used for the advanced notice includes the Broadcast TV Network 120, the Private Network 125, the Cable Network 135, the Internet 130, the Satellite Network 140, or any Other System 141. In step 415, the Promoters and the Advertisers communicate the availability of future CR\overline{A}V Ads to the Consumers 110 using the chosen Broadcast Network(s) 105. In step 416, the promoter decides whether to allow the Consumers 110 to pre-register. If the answer is “NO,” then the process moves to step 215 of FIG. 2. If the answer is “YES,” the process moves to step 420.

In step 420, the Consumers 110 decide whether or not to register to respond to the CR\overline{A}V Ads using the Device 111. If the answer to step 420 is “NO,” the process moves to step 215 of FIG. 2. In one alternative exemplary embodiment, the CR\overline{A}V Ad system is simple, and registration is not required. However, in alternative exemplary embodiments, registration is required during the process. Registration allows the Promoters and the Advertisers to collect detailed information about the Consumers 110. If the answer to step 420 is “YES,” the Consumers 110 register, as set forth in step 425. The process then moves to step 215 of FIG. 2.

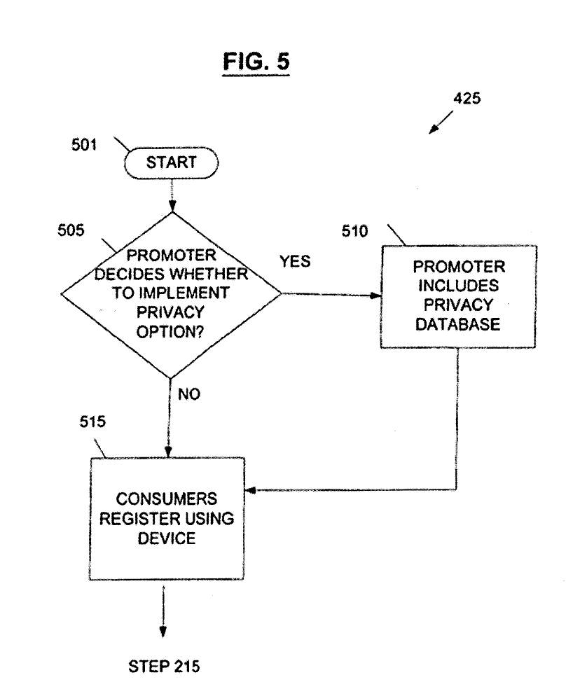

FIG. 5 is a flow diagram illustrating an exemplary process describing how the privacy option applies to the registration process, as set forth in step 425 of FIG. 4. Turning now to FIG. 5, an exemplary CR\overline{A}V Ad process 425 is initiated at the “START” step 501. In step 505, the Promoters decide whether to implement the privacy option. The privacy option segregates confidential personal data from demographic data. If the privacy option is used, the Data Storage Center 195 includes the Privacy Database 199, as set forth in step 510. The process then moves to step 515. If the privacy option is not implemented, the process moves directly from step 505 to step 515. In step 515, the Consumers 110 register using the Device 111, and the process moves to step 215 of FIG. 2.

The privacy option is important because it allows the Consumers 110 to be less concerned that their personal registration information will be matched with their demographic and response information by outside parties.

Registration

Because the Query 1820 may be short in duration, the Consumers 110 may not be able to fully register and respond to the CR\overline{A}V Ad within the allocated CR\overline{A}V Ad time. Therefore, the Consumers 110 will usually want to register before the CR\overline{A}V Ad is broadcast. Several registration options are available.

Registration information may include a variety of data. In one exemplary embodiment, the Promoters do not want to use demographic information and simply seek to identify the Consumers 110 for tracking and prize awarding purposes. The Consumers 110 are thus asked to provide simple information where they may be reached and identified if selected as a winner. This information may include a phone number, a social security number (or portion thereof), a birthday, a name, and an address. After providing the registration information, the Consumers 110 are provided with a unique “CR\overline{A}V ID”. This number may be a randomly generated unique number, or an easily remembered number or a series of numbers (such as a birthday and phone number combination), which may also provide ID information within the number.

In another exemplary embodiment for registration, the Promoters may wish to obtain ID information, product-related information, or public opinion-related information. The demographic profile of each Consumer 110 may include age, sex, race, weight, height, zip code, physical home or e-mail address, occupation, individual annual earning, educational background, political affiliation, religious affiliation, family size, number of TVs and computers, Advertiser-related or public opinion survey questions, and prior CR\overline{A}V Ad answers (historical response information). A detailed registration may be required for each CR\overline{A}V Ad. However, gathering this information for each CR\overline{A}V Ad makes the registration process time-consuming, costly, and redundant, and may deter the Consumers 110 from submitting a response. Thus, a one-time registration process is also available. In this mode, only changed/updated demographic or ID information (such as a change in marital status, phone number, etc.) is added for each CR\overline{A}V Ad response after the original registration. Under this scenario, the original registration information is stored in the PDC 197. As new responses or update information are transmitted to the Data Storage Center 195, the Data Storage Center 195 is updated.

In another alternative embodiment for registration, when only one registration is used (as described above), the Advertisers may have the Consumers 110 with existing CR\overline{A}V IDs enter additional demographic information to be qualified for the rewards. In this case, new “response” information is added for each additional CR\overline{A}V Ad response after the original registration. Under this scenario, the original registration information would be stored in the DCS 196, and as new responses are transmitted to the Data Storage Center 195, the registration information can be added to the Data Storage Center 195. The CR\overline{A}V ID would be required before allowing additions to CR\overline{A}V Ad records.

Broadcast CR\overline{A}V Ad and Interaction with Consumers

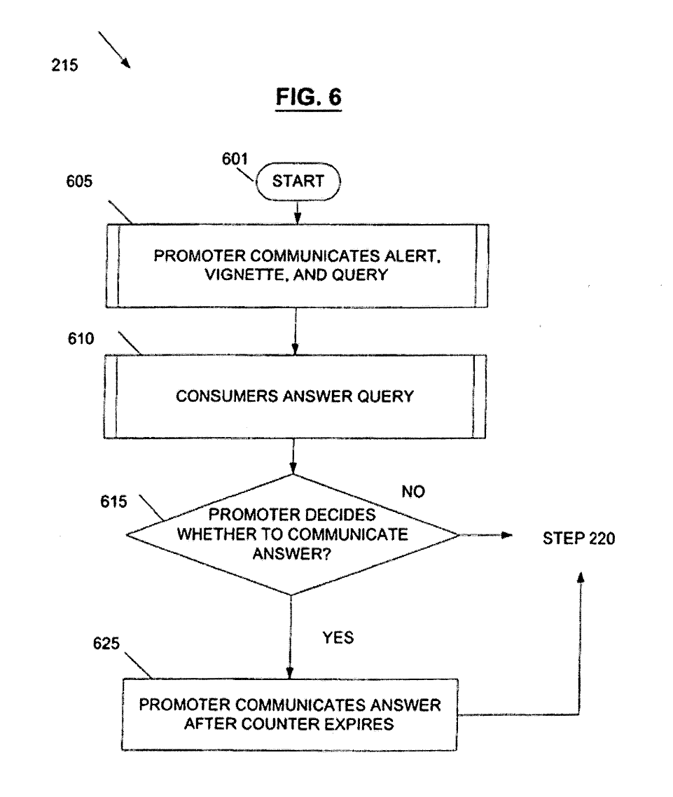

FIG. 6 is a flow diagram illustrating an exemplary process describing how the Promoters use the Broadcast Network 105, the Device 111, the Information Gathering System 112, and the Data Storage Center 195 to communicate the CR\overline{A}V Ads to the Consumers 110 and to interact with the Consumers 110, as set forth in step 215 of FIG. 2. Turning now to FIG. 6, an exemplary CR\overline{A}V Ad process 215 is initiated at the “START” step 601. In step 605, the Promoter communicates the Alert 1805, the Vignette 1810, and the Query 1820 using the Broadcast Network 105. The Alert 1805 is a warning to the Consumers that the upcoming Vignette 1810 should be memorized so the Consumers may become eligible to win a reward. The Vignette 1810 may be a conventional commercial for a product or service or any other information designed for presentation to a consuming audience. The Query 1820 includes one or more questions. In step 610, the Consumers 110 answer the Query 1820. In step 615, the option to communicate the Answer 1830 is provided, based on whether or not the Promoters wish to use this option. The Answer 1830 includes the answer to at least one of the Query's 1820 question or questions. If the answer to step 615 is “NO”, and the Answer 1830 is not communicated, the process moves to step 220 of FIG. 2. If the answer to step 615 is “YES”, the Promoter communicates the Answer 1830 after the counter time has expired using the Broadcast Network 105, as set forth in step 620. The process then moves to step 220 of FIG. 2.

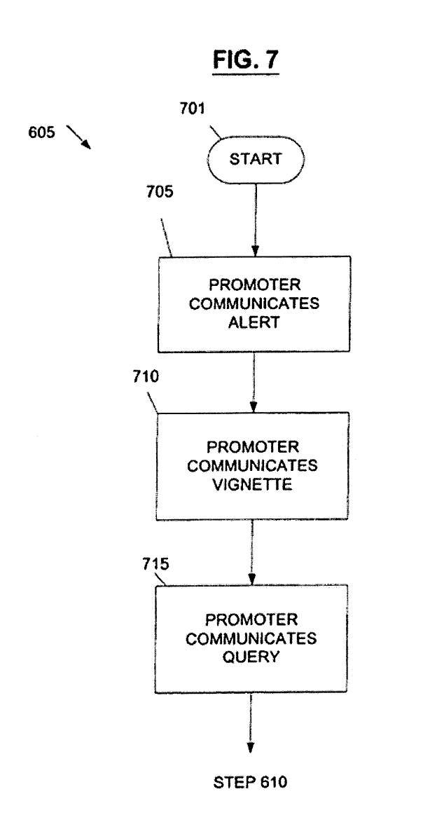

FIG. 7 is a flow diagram illustrating an exemplary process describing how the Promoter communicates the Alert 1805, the Vignette 1810, and the Query 1820 using the Broadcast Network 105, as set forth in step 605 of FIG. 6. Turning now to FIG. 7, an exemplary CR\overline{A}V Ad process 605 is initiated at the “START” step 701. In step 705, the Promoter communicates the Alert 1805 using the Broadcast Network 105. The Alert 1805 may include a prize description and an Advertiser and/or Promoter logo. The Alert 1805 may also include any other information the Promoters, or some other entity, wishes to display. In step 710, the Promoter communicates the Vignette 1810 using the Broadcast Network 105. The Vignette 1810 may include an Ad and the Advertiser and/or Promoter logo. The Vignette 1810 may also include any other information the Promoters, or some other entity, wishes to display. In step 715, the Promoter communicates the Query 1820 using the Broadcast Network 105. Alternatively, the Promoter can communicate the Query 1820 using one or more of the response devices 111. The Query 1820 may include questions, possible answers, login response information, a time remaining counter, and the Advertiser and/or Promoter logo. The CR\overline{A}V Ad Query 1820 may also include any other information the Promoter wishes to include. The process then moves to step 610 of FIG. 6.

CR\overline{A}V Ad is Answered

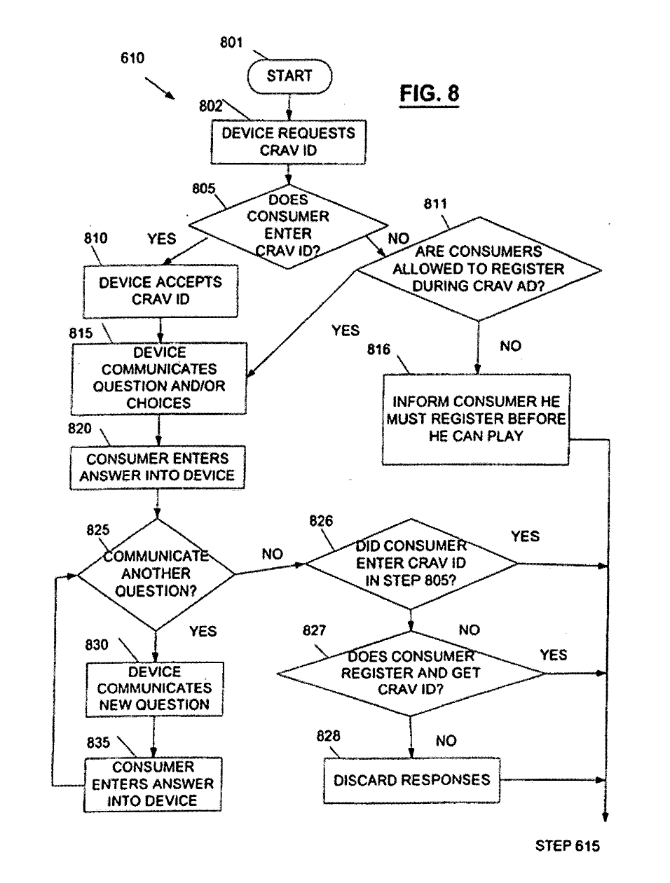

FIG. 8 is a flow diagram illustrating an exemplary process describing how the Consumers 110 answer the CR\overline{A}V Ads, as set forth in step 610 of FIG. 6. Turning now to FIG. 8, an exemplary CR\overline{A}V Ad process 610 is initiated at the “START” step 801. In step 802, the Device 111 prompts the Consumers 110 to enter their CR\overline{A}V ID. In step 805, it is determined whether or not Consumers 110 have entered a CR\overline{A}V ID. If the answer to step 805 is “NO” and the Consumers 110 do not enter a CR\overline{A}V ID, registration may be allowed, as set forth in step 811. If registration is allowed, the process moves to step 815. If registration is not allowed, the Consumers 110 are informed that they must register before they can submit a response to the CR\overline{A}V Ad, as set forth in step 816. The process then moves to step 615 of FIG. 6.

If the answer to step 805 is “YES”, and the Consumers 110 have entered a CR\overline{A}V ID using the Device 111, the Device 111 accepts the CR\overline{A}V ID as set forth in step 810. The CR\overline{A}V ID may be a number assigned by the Promoter or the Advertiser. It may be stored in memory to eliminate the need for manual entry. Examples of how to store the CR\overline{A}V ID into memory include using a cookie over the Internet, or entering a stored number into a phone (speed dial memory function). In step 815, the Broadcast Network 105 or Device 111 communicates the first question of the CR\overline{A}V Ad Query 1820 and the answer choices. The question can be an immersion verification question, a polling question, a trivia question, or any other type of question. The answer choices may be a set of predetermined response options a, b, c, d, etc., or the Consumers 110 may be required to enter the answer itself. The options for answering may include the broadcast of unique numbers or letters that may differ between broadcasters, that allow subsequent decoding by the Data Storage Center 195 to determine the broadcast medium or location used by the Consumers 110 to view the CR\overline{A}V Ad. In step 820, the Consumers 110 enter their answer into the Device 111. In step 825, the Promoters may communicate another question as part of the same Query 1820 using the Broadcast Network 105 or Device 111. This question may be another immersion verification question, or a question used to get information about the Consumers 110. This information may include demographic information or other information. If the Promoter chooses “YES” to decision step 825, the process moves to step 830, and the Device 111 communicates the new question. In step 835, the Consumer enters the answer into the Device 111. The process then moves back to step 825 and is repeated. If the answer to step 825 is “NO”, and no other questions will be asked, the process moves to step 826. In step 826, it is determined whether or not the Consumer 110 entered a CR\overline{A}V ID in step 805. If the answer to step 826 is “YES”, the process moves to step 615 of FIG. 6. If the answer to step 826 is “NO”, the process moves to step 827, where Consumers 110 have the option to register. If the answer to step 827 is “YES”, and the Consumers 110 register, the process moves to step 615 of FIG. 6. If the answer is “NO”, and the Consumers 110 don't register, or don't completely register, the process moves to step 828 and the responses are discarded. The process then moves to step 615 of FIG. 6.

CR\overline{A}V Ad Answers Are Gathered

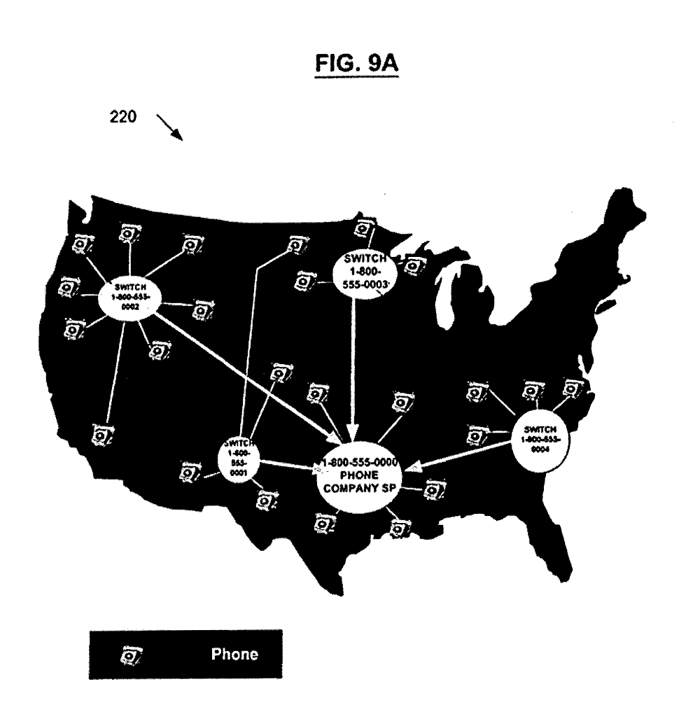

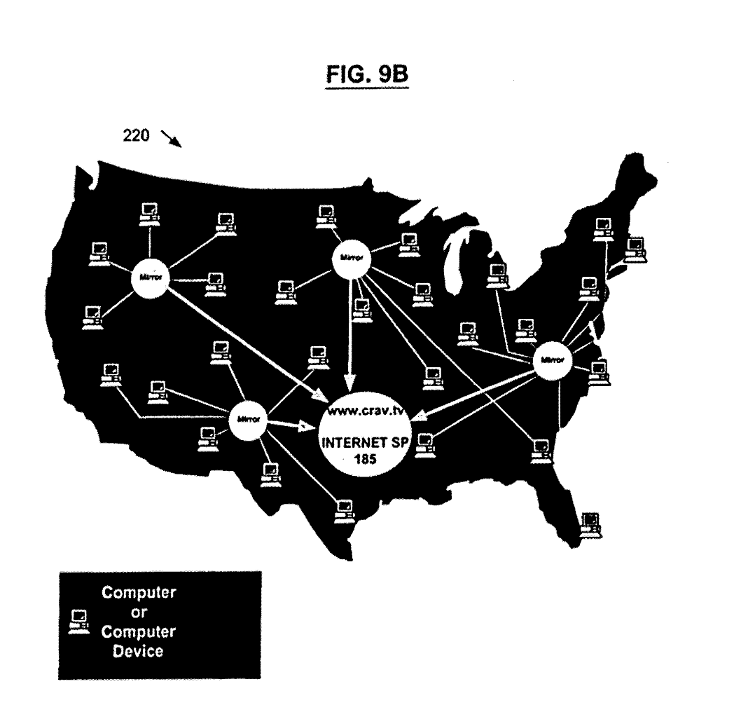

FIGS. 9A and 9B, together comprising FIG. 9, are picture diagrams illustrating an exemplary nationwide network for gathering the registration and response information, as set forth in step 220 of FIG. 2. The Query 1820 gathering network is designed to accommodate two variables in any data collection activity. First, expected traffic and geographic/time zone requirements must be met. Second, the registration and the response information must be sent to the Data Storage Center 195. FIG. 9A illustrates the United States map, and shows how conventional Phones 145 forward the registration and the response information to the Phone Company SP 170. FIG. 9B illustrates the United States map, and shows how the Internet computer 130 forwards the registration and the response information to the Internet SP 185. Although the Figures illustrate the United States, one experienced in the art will recognize that the collection system may be implemented in any country, or in multiple countries.

Turning now to FIG. 9A, a network is illustrated showing how Consumer responses are forwarded by the Phone 145 to the Phone Company SP 170. Those experienced in the art will recognize the multiple ways to meet expected traffic and geographic/time zone requirements. Similar to traffic terminology, the traveling information is called “traffic”, the length between two points is “distance”, and impeded traffic is “congestion.” In an exemplary embodiment, a single Web site and a single phone number would be sufficient to handle Query 1820 responses. However, in most cases, multiple lines are necessary to handle the numerous response traffic.

For telecommunication lines, design elements may assist in reducing distance and avoiding congestion. For example, multiple phone numbers (connected to one or multiple Information Gathering Systems 112) may be located in geographically centered locations. In addition, one published phone number, which incorporates a switch directing incoming calls to one or multiple Information Gathering Systems 112, may be located in geographically centered locations, directed based on the incoming call's origin point. FIG. 9A illustrates the option of the Phones 145 forwarding the registration and the response information to the Phone Company SP 170.

For responses provided over a network such as the Internet Network 130, the following design elements may assist to reduce distance and avoid congestion: mirrored Web sites with unique Web site addresses (each serving as a Information Gathering System 112) located in geographically centered locations; one published Web site address, which is redirected to one or more mirrored Web sites ideally located in geographically centered locations near the user's SP 112; and unique Web sites hosted by individual Internet SPs 185 or approved Information Gathering Systems 112. FIG. 9B illustrates the option of the Internet computer 160 forwarding the registration and the response information to the Internet SP 185.

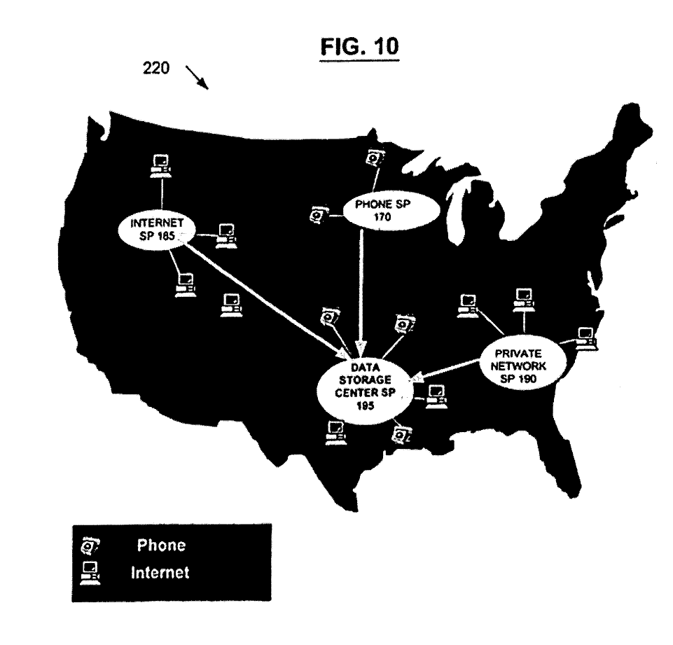

FIG. 10 shows how the Information Gathering System 112 sends the registration and the response information to the Data Storage Center 195. The registration and the response information is sent to the Information Gathering Systems 112 that may be hosted by a SP network. A CR\overline{A}V Web site may also be set up to be the Information Gathering System 112. This CR\overline{A}V Web site may be housed at the same location as the Data Storage Center 195. Once the CR\overline{A}V Ad has concluded, the Information Gathering System 112 forwards the registration and the response information to the Data Storage Center 195 on a time scheduled, synchronized basis. Once the Consumers' 110 data is received and verified by the Data Storage Center 195, the response information may be programmed for automatic erasure by the Information Gathering System 112. FIG. 10 illustrates three Information Gathering Systems 112 for forwarding registration and response information: an Internet SP 185, a Phone Company SP 170, and a private network SP 190.

CR\overline{A}V Ad Winners Selected and Prizes Distributed

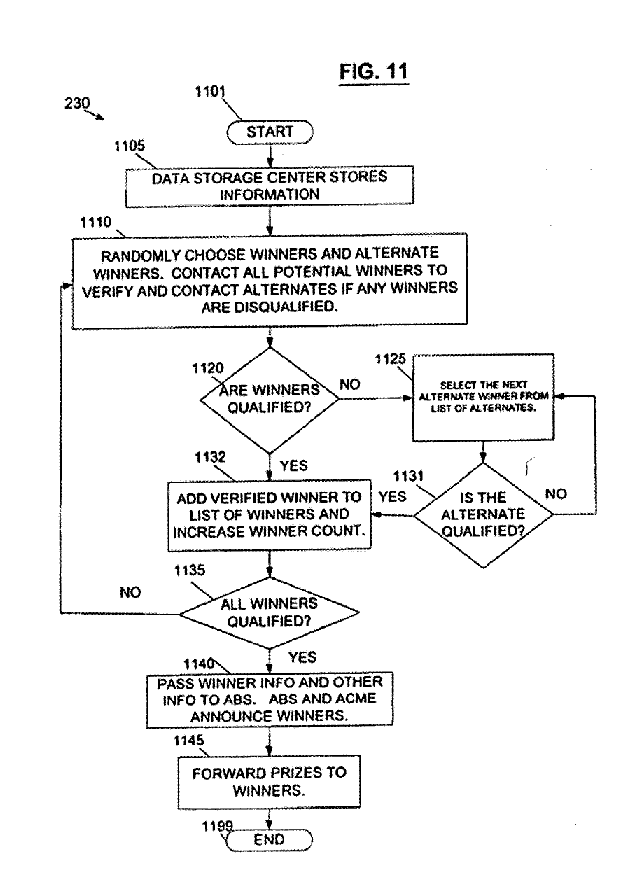

FIG. 11 is a flow diagram illustrating an exemplary process describing how the Promoters select winners and distribute prizes, as set forth in step 230 of FIG. 2. Turning now to FIG. 11, an exemplary CR\overline{A}V Ad process 230 is initiated at the “START” step 1101. In step 1105, The Data Storage Center 195 stores the registration information in the PDC 197 and the response information in the DCS 196. In step 1110, the Promoters or a third party service provider randomly choose winners and alternate winners from the DCS 196 database. The DCS 196 database includes a list of the Consumers 110 who have correctly answered all required questions. The Promoters, the Advertisers, or a third party service provider, also contact the potential winners. (This third party service provider may also offer fulfillment services including information on Consumer answers and coupons.) Based upon the process selected by the Promoters or the Advertisers, the potential winner identities and the truthfulness of the potential winners' registration and response information may be verified. If this option is used, the Promoters verify the identity by authenticating the Consumers' registration and response information. The Promoters may require potential winners to verify demographic or confidential data prior to awarding the prize. The Promoters may repeat the one or more questions in the Query 1820. The Promoters may elect to disqualify potential winners who fail to provide responses that match their Query 1820 responses.

In step 1120, it is determined if the winners are qualified for the prizes. If the answer to step 1120 is “NO”, the process moves to step 1125, and the next alternate winner is selected from the list of alternate winners. In step 1131, it is determined if the alternate winner is qualified. If the answer to step 1131 is “NO”, the process moves back to step 1125 and is repeated. If the answer to step 1131 is “YES”, the process then moves to step 1132.

If the answer to step 1120 is “YES”, the process moves to step 1132, and the verified winner is added to the list of winners and the winner count is increased. In step 1135, it is determined if all winners are qualified. If the answer to step 1135 is “NO”, the process moves to step 1110 and is repeated. If the answer to step 1135 is “YES”, the process moves to step 1140. In step 1140, the winner information and other opted information (i.e., demographically pertinent data and Query 1820 response results) may be forwarded to Advertisers and/or other interested entities, particularly if Consumers 110 have approved the forwarding of said information. The Promoters, the Advertisers, or a third party service provider also announce the winners. In step 1145, the Promoters, the Advertisers, or third party service provider forwards the prizes to the winners. The process then ends at step 1199.

Other Applications for CR\overline{A}V Ads

While the above description is ideally suited for visual mass media technology such as the TV and the Internet 130, it may also be utilized in alternate mass media channels, using audio-only technology like radio, or visual-only broadcast mediums, such as a magazine or newspaper ad. The CR\overline{A}V Ads may be answered with complicated, highly-developed computer Devices 111, or simply by using the Phone 145. Those practiced in the art will recognize the above invention may be implemented with any broadcast medium and response medium. In addition, the invention is not limited to providing ads within entertainment content, but can be extended to providing other types of information. Finally, while the invention has been discussed in the context of the Consumers 110, the Promoters, and the Advertisers, those experienced in the art will recognize that other entities can be used. For example, a third party service provider can be responsible for: gathering the registration and response information, screening the registration and response information to validate it, mining the registration and response information to extract pertinent data, randomly selecting the winners and alternate winners, and providing prize fulfillment and delivery verification services.

### EXAMPLE

To better illustrate the CR\overline{A}V Ad process, a representative example is provided. The Promoter is ABS Broadcasting Company (“ABS”) and the Advertiser is ACME Motors (“ACME”). The Consumers 110 are a four person family in Largo, Fla. Mr. Daly is 60 years old and Mrs. Daly is 58. Two sons live at home. Mike is 25, Mark is 23.

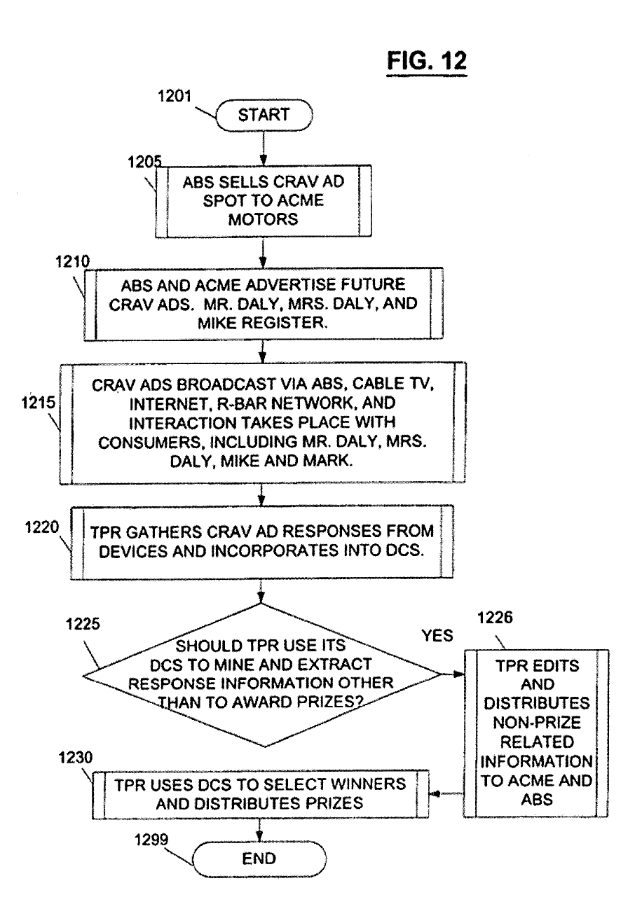

FIG. 12 is a flow diagram illustrating a CR\overline{A}V Ad example. An exemplary process is initiated in step 1201. In step 1205, ABS sells two two-minute CR\overline{A}V Ad slots to ACME Motors (“ACME”). In step 1210, ABS and ACME advertise the future broadcast of CR\overline{A}V Ads, and as a result, the Dalys register. In step 1215, the CR\overline{A}V Ads are broadcast. In step 1220, the CR\overline{A}V AD responses are gathered. In step 1225, the DCS is utilized to use the gathered information for purposes other than awarding prizes. In step 1226, the DCS mines, extracts, edits and forwards the non-prize winner related information. In step 1230, the DCS is utilized to select the winners and distributes the prizes.

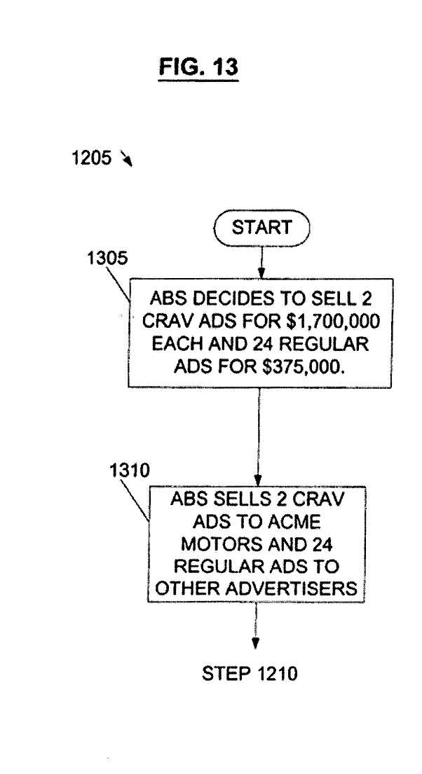

FIG. 13 is a flow diagram illustrating how the Ad slots are sold, as set forth in step 1205 of FIG. 12. Turning now to FIG. 13, ABS decides to sell the two CR\overline{A}V Ads for $1,700,000 each and the twenty-four regular ads for $375,000 each, as set forth in step 1305. ABS sells the two CR\overline{A}V Ads to ACME, and the twenty-four regular ads to other Advertisers, as set forth in step 1310. The process then moves to step 1210 of FIG. 12.

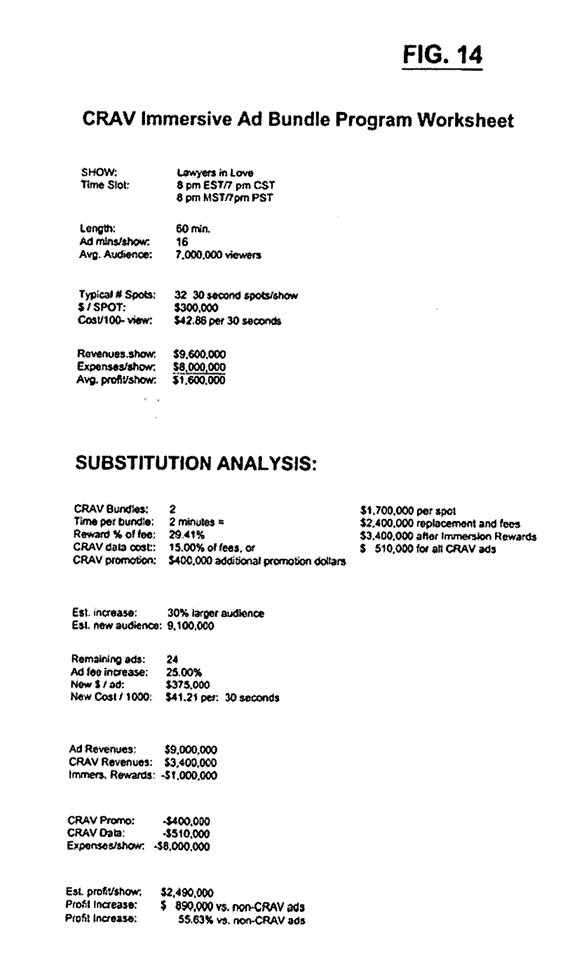

To determine the ad price, ABS follows the chart set forth in FIG. 14. ABS determines the average profit for a show “Lawyers in Love”. “Lawyers in Love” is shown at 8 PM EST/8 PM MST (broadcast over delayed time slots) and has a length of 60 minutes. The show's average viewing audience is 7 million Consumers 110. ABS has allocated 16 advertising minutes (32 30-second spots) for the show. ABS charges $300,000 per 30-second spot to Advertisers, earning $9.6 million revenue per show. The show expenses are $8,000,000. Thus, the average profit is show revenue ($9.6 million)−show expenses ($8 million)=net profit ($1.6 million). The average cost to the Advertiser per 1000 Consumers 110 is $42.86, without taking the CR\overline{A}V Ads into account.

ABS then determines the substitution analysis. The two CR\overline{A}V Ads priced at $1,700,000 replace (8) 30-second ad slots, for which ABS had formerly garnered $2.4 million in revenue. ABS also wishes to allocate $1 million for prizes, bringing the CR\overline{A}V Ad price to $3.4 million. The CR\overline{A}V data gathering cost is $510,000. ABS pays this fee to TPR, a third party information warehousing and collection organization equipped with CR\overline{A}V related registration and Information Gathering System 112. TPR will also select winners and alternates, authenticate winner responses, provide a list to ABS and ACME, and will handle the prize distribution process. ABS spends $400,000 promoting the future CR\overline{A}V Ads.

ABS estimates the CR\overline{A}V Ad contest will increase the audience by 30%. ABS therefore increases the traditional ad price by 25%. The new ad price is $375,000 for each 30-second slot. The Advertisers are therefore paying $375,000 per 30-second regular ad (as opposed to $300,000), but are in exchange potentially achieving higher immersion levels, and their regular ads are being broadcast to a larger audience at a lower cost per impression. The new cost per 1000 Consumers 110 is lower: $42.21.

This $75,000 increase per slot, over 24 slots, adds $1.8 million in additional revenues to ABS. This is offset by the $400,000 additional cost to promote the upcoming CR\overline{A}V Ads, plus $510,000 for CR\overline{A}V information collection, compilation and winner selection/verification. Thus, ABS realizes $890,000 in additional net profit. This increases the show's profitability by over 55%.

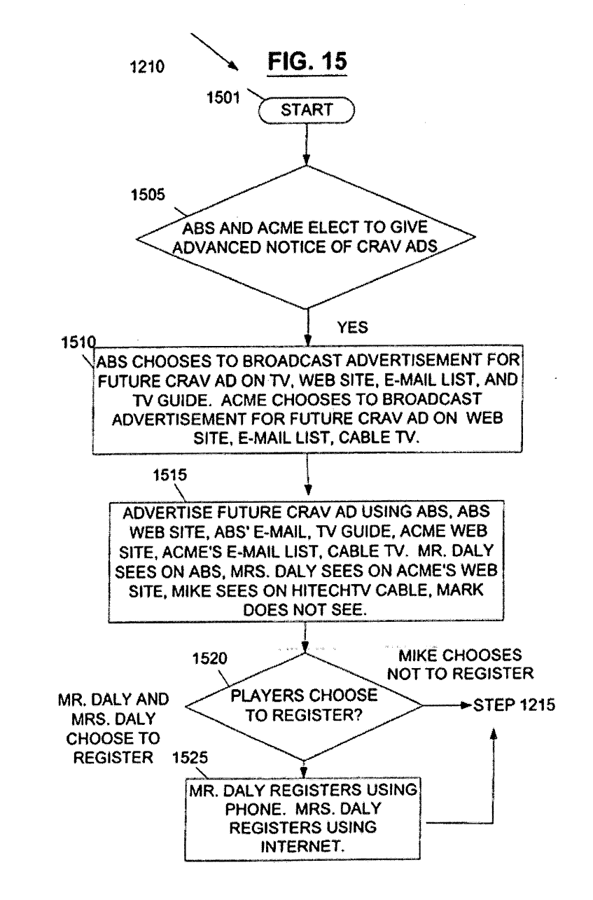

FIG. 15 is a picture flow diagram illustrating an exemplary CR\overline{A}V Ad process for ABS and ACME to promote future CR\overline{A}V Ads, as set forth in step 1210 of FIG. 12. In step 1501, the process 1210 is initiated at the “START” button 1501. In step 1505, ABS and ACME elect to promote and give advanced notice of the CR\overline{A}V Ads. In step 1510, ABS chooses to promote the CR\overline{A}V Ads on TV, the Internet 130, e-mail, and TV guide, and ACME chooses to promote the CR\overline{A}V Ads on the Internet 130, e-mail, and cable TV. As set forth in step 1515, during the weeks before the broadcast, ABS promotes the upcoming “CR\overline{A}V/ACME New Car Giveaway” promotion on its own ABS network. ABS also purchases TV guide magazine ads, posts information on the ABS Web site, and sends out information to its e-mail lists. Also promoting the CR\overline{A}V Ads are ACME's own banners om its Web site and e-mail notification to its 3.5 million subscribers. ACME also advertises on the HiTechTV cable channel network. Mr. Daly sees the CR\overline{A}V Ads promoted on ABS. Mrs. Daly sees the CR\overline{A}V Ads promoted on ACME's Web site while surfing the Internet 130. Mike sees the CR\overline{A}V Ads promoted on HiTechTV cable. Mark does not see the CR\overline{A}V Ads promoted. The CR\overline{A}V Ad promotion states: “Watch ‘Lawyers in Love’ on Sunday at 8:00 EST and you may win 1 of 50 new ACME convertibles. Register at www.CR\overline{A}V.tv or by calling 1-800-CR\overline{A}VNOW.” All broadcast promotions for the future ACME CR\overline{A}V Ads include this registration information. Registration is conducted by TPR.

Following step 1520, Mr. Daly and Mrs. Daly choose to register. Mike chooses not to register at this time. Mark does not know he may register, and therefore does not register. As set forth in step 1525, Mr. Daly registers using the Phone 145, and Mrs. Daly registers using the Internet computer 160. The process then moves forward to step 1215.

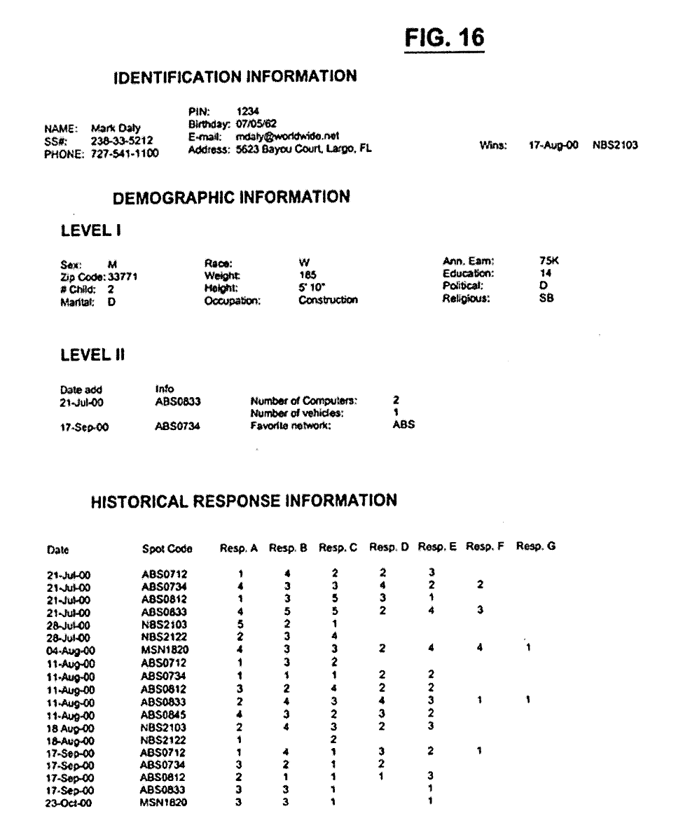

The registration process involves having Mr. Daly and Mrs. Daly enter registration information. FIG. 16 shows a sample CR\overline{A}V record, which may include a name, Social Security number, phone number, PIN, birthday, e-mail, address, and any wins. The Promoters may also ask the Consumers 110 to enter demographic information, which may include sex, zip code, number of children, marital status, race, weight, height, occupation, annual earnings, education, political affiliation, and religious affiliation. This information may be supplemented and updated with information including: the number of TVs and computers owned, the number of vehicles owned, and the favorite TV network. The historical response information provides information on the responses the Consumers 110 have given to prior CR\overline{A}V Ads.

While the Consumers 110 may enter demographic information during the registration process, the Query 1820 also provides an opportunity to gather demographic information. This information may be added to the CR\overline{A}V demographic information, or may be added to the historical response data. In this case, a Level II demographic record may be incorporated into the record, for easier search and compilation in the future. Level II demographic information is collected after the initial registration point and thus may contain information for some, but not all, Consumers 110. As a result, Level II demographic information may limit the total survey population, as opposed to the primary Level I demographic information, which is provided by all registrants at initial registration.

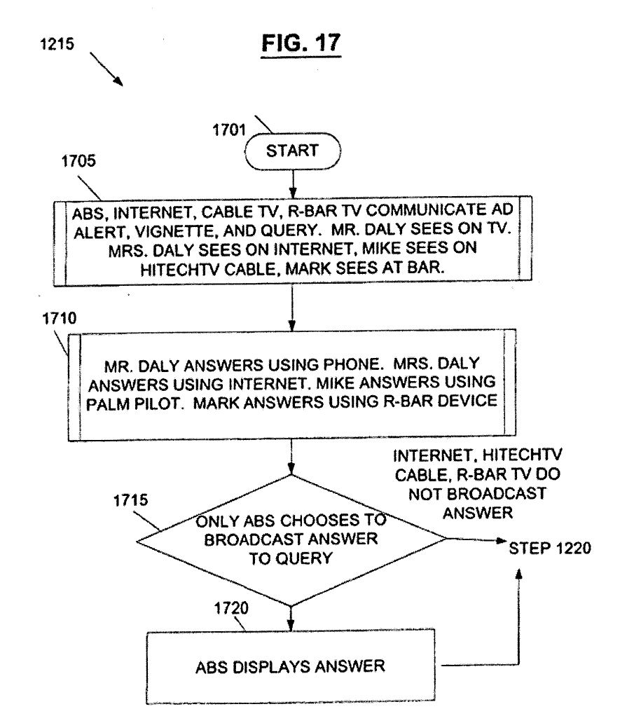

FIG. 17 is a flow chart illustrating an exemplary embodiment of step 1215, where ABS broadcasts the Alert 1805, the Vignette 1810, and the Query 1820. Turning now to FIG. 17, the process 1215 is initiated at the “START” step 1701. In step 1705, ACME elects to utilize the MultiSimulcast concept, by offering simultaneous ACME CR\overline{A}V Ad broadcasts over multiple Devices. ACME chooses to show the ACME CR\overline{A}V Ad on ABS, ACME's Web site, HiTechTV Cable, and the R-BAR Network simultaneously at 8:33 PM EST on Sunday. Therefore, identical ACME CR\overline{A}V Ads are MultiSimulcast on these mediums at 8:33 PM EST. Mr. Daly sees the ACME CR\overline{A}V Ad while watching “Lawyers in Love” on ABS 120. Mrs. Daly sees the ACME CR\overline{A}V Ad while logged on to the Internet 130. (Mrs. Daly already provided her CR\overline{A}V ID when she logged on.) Mike is watching HiTechTV Cable 135 in his room, and sees the ACME CR\overline{A}V Ad. Mark sees the ACME CR\overline{A}V Ad at a local bar, using the R-Bar Network 125. In step 1710, the Consumers 110 answer. Mr. Daly answers using the Phone 145. Mrs. Daly answers using the Internet computer 160. Mike answers using his Palm Pilot PDA 150, although Mike has not yet registered. Mark answers using the R-Bar Device 165. The Answer 1830 to the Query 1820 is shown only on ABS, as set forth in step 1715-1720. The Answer 1830 is not shown on the Internet 130, the HiTechTV Cable 135, and the R-Bar Network 125.

FIG. 18 illustrates the CR\overline{A}V Ad the Consumers 110 see, as set forth in FIG. 17. In step 1805, the Alert 1805 is pictured. The Alert 1805 states: “Memorizing the following ACME CAR COMPANY CR\overline{A}V Ad may make you a winner of 1 of 50 new ACME convertibles.” This Alert 1805 is shown for 10 seconds. In step 1810, the Vignette 1810 is broadcast. The Vignette 1810 is a 60-second entertaining and informative ad suitable for broadcast in non-CR\overline{A}V Ads as well. In step 1820, the Query 1820 is broadcast. The Query 1820 includes three questions: an immersion verification question 1820a broadcast over Broadcast Network 105, including ABS, ACME's web site, HiTechTV, and R-BAR private broadcast network; and an Advertiser question 1820b, and polling question 1820c, both of which are distributed via Devices 111, including a telephone network, ACME's Web Site, R-Bar private Network, and Palm Pilot PDA Network. The immersion verification question 1820a asks “What new ACME model features side impact air bags?” The multiple choice responses are displayed or vocalized: 1) SD2020, 2) XP2030, 3) XX2040, 4) XYZ123. The second question, the Advertiser question 1820b, is communicated. This is a question designed by the Advertiser, posed to the Consumers 110 while responding through the various Devices 111. This question asks “When do you plan on buying a new car?” The multiple choice responses are displayed or vocalized: 1) 2 years or over, 2) within 2 years, 3) within 1 year, 4) within 6 months. In step 1820c, the third question, the polling question 1820c, is displayed or vocalized. This question is designed for a contracted pollster, posed to the Consumers 110 while responding through the various Devices 111. This question asks “Assuming the following choices, for whom do you plan to vote for U.S. President in 2008?” The multiple choice responses are displayed or vocalized: 1) Hillary Clinton, 2) Colin Powell 3) Jeb Bush 4) Frank Maggio. In step 1830, the correct answer to question 1 is displayed or vocalized: XP2030.

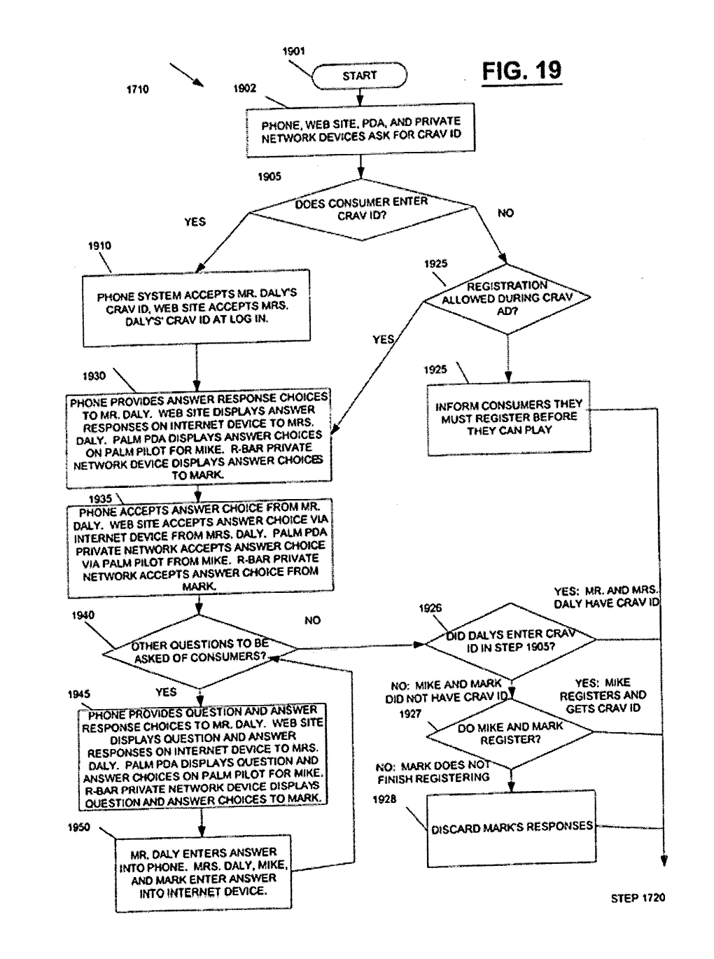

FIG. 19 is a flow diagram illustrating how the CR\overline{A}V Ads are answered by the Dalys, as set forth in step 1710 of FIG. 17. For Mr. Daly, the process is as follows. Mr. Daly answers using the Phone 145, by dialing a phone number he was given when he registered. The phone number connects to an answering service, which asks Mr. Daly for his CR\overline{A}V ID, as set forth in step 1902. Mr. Daly has already registered, so he enters his CR\overline{A}V ID and it is accepted in step 1910. In step 1930, the Phone 145 plays Mr. Daly the first question 1820a with answer choices. In step 1935, he answers “SD2020” by pressing 1 on his touch-tone Phone 145, as prompted. (This is not the correct response.) Another question is asked, so the process moves from step 1940 to step 1945. In step 1945, Mr. Daly is asked the second question 1820b with answer choices. In step 1950, Mr. Daly answers “2 years and over” by pressing 1 on his Phone 145. A third question 1820c is asked, so the process moves from step 1940 to step 1945. In step 1945, Mr. Daly is asked the third question. In step 1950, Mr. Daly answers he will vote for “Frank Maggio” for President by pressing 4 on his Phone 145. (This is evidence of his political acumen.)

For Mrs. Daly, the process is as follows: Mrs. Daly answers using the Internet Computer 160. As Mrs. Daly already provided her CR\overline{A}V ID automatically when she logged on (steps 1902-1910), she only needs to answer the questions. In step 1930, the Internet 130 shows the immersion verification question 1820a. In step 1935, Mrs. Daly selects “XP2030”. In step 1945, the Internet Network 130 shows the Advertiser question 1820b with answer choices. In step 1950, Mrs. Daly selects “within 2 years”. Because there is another question, the process moves from step 1940 to step 1945 again. In step 1945 the polling question 1820c with answer choices is shown. In step 1950, Mrs. Daly selects “Frank Maggio” representing her choice for President. (Intelligence runs in the Daly household.)

For Mike, the process is as follows: Mike uses his Palm Pilot 150 to access the Web site shown on HiTechTV Cable 135. Mike has not registered, but registration is allowed, so the process moves from step 1905, to step 1925, where registration is allowed, and then to step 1930. In step 1930, the immersion verification question 1820a with answer choices is displayed. In step 1935, Mike answers 3 (“XX2040”). There is another question so the process moves from step 1940 to 1945. In step 1945, the Advertiser question 1820b with answer choices is displayed. In step 1950, Mike answers 3 (“within 1 year”). The same process is followed for the polling question 1820c, and Mike answers it. There are no additional questions, so the process moves from step 1940 to step 1926. In step 1926, because Mike does not have a CR\overline{A}V ID, the process moves to step 1927 and Mike registers and gets a CR\overline{A}V ID, which is automatically entered. The process then moves to step 1720.

For Mark, the process is as follows: Mark uses the bar's private network, which broadcasts the CR\overline{A}V Ads and presents the Query 1820 to the Consumers 110 located within the bar who are connected to the private network and who have enrolled to play. Mark is asked for his CR\overline{A}V ID in step 1902. Mark has not pre-registered, so Mark types “NONE”, and the process moves to step 1905, and then to 1925. In step 1925, registration is allowed during the CR\overline{A}V Ad, so the process moves to step 1930. In step 1930, the immersion verification question 1820a with answer choices is displayed. In step 1935, Mark answers 3 (“XX2040”). Another question is asked, so the process moves from step 1940 to 1945. In step 1945, the Advertiser question 1820b with answer choices is displayed. In step 1950, Mark answers 3 (“within 1 year”). Another question is asked, so the process moves from step 1940 to 1945. In step 1945, the polling question 1820c with answer choices is displayed. In step 1950, Mark answers 1 (“Hillary Clinton”). No other questions are asked, so the process moves from step 1940 to step 1926. In step 1926, the Device recognizes that Mark does not have a CR\overline{A}V ID. The process moves to step 1927, and Mark is asked if he wishes to follow the registration process (to obtain a CR\overline{A}V ID) or lose his Query 1820 response information. Mark starts to complete the registration information, but is distracted and logs off. Because he does not complete the registration, he is not assigned a CR\overline{A}V ID, and his responses are discarded, as set forth in step 1928.

In step 1220 of FIG. 12, the CR\overline{A}V Ad answers are gathered. This is done by the Phone Company SP 170, the Internet SP 185, the PDA SP 175, and the R-Bar Private Network SP 190 forwarding the response and applicable registration information to TPR's DCS 195.

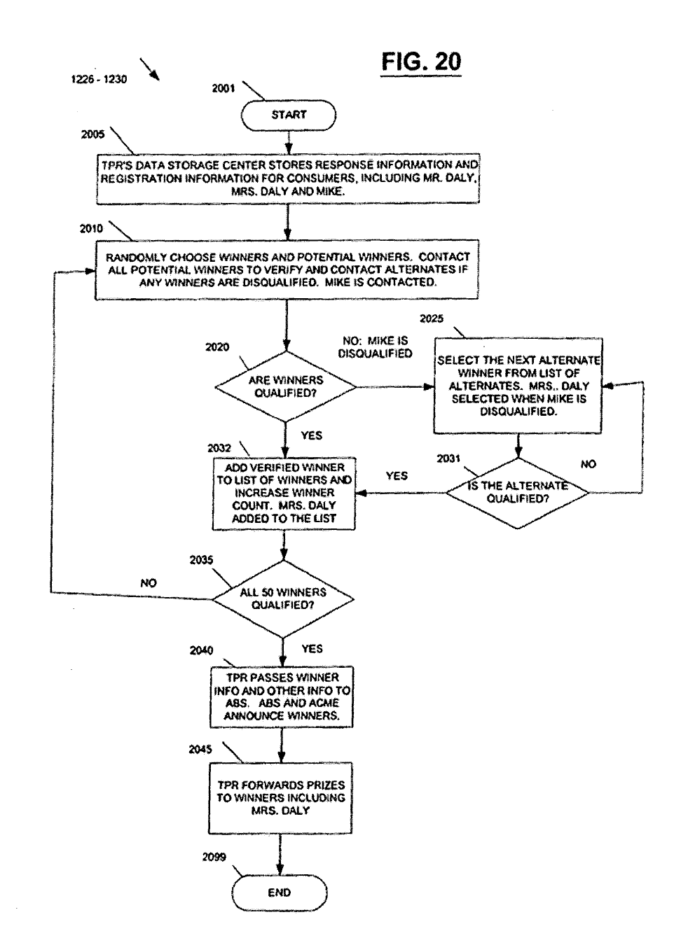

FIG. 20 is a flow diagram illustrating how TPR uses the Data Storage Center 195 to select winners and distribute the prizes, as set forth in step 1226 and 1227 of FIG. 12. In step 2001, the process is initiated at the “START” button. In step 2005, TPR's Data Storage Center 195 stores the registration information (for those who registered during game play) and the DCS 196 stores the response information for all the registered Consumers 110, including Mr. Daly, Mrs. Daly, and Mike. In step 2010, the potential and alternates winners are randomly chosen and extracted from all the correct answers for question 1820a stored within the DCS 196. Mike is chosen as a one of 50 winners and Mrs. Daly is chosen as the first of 50 alternate winners. TPR begins the verification process by contacting all 50 winners. Each winner is qualified in step 2020, and as each winner is verified their name is added to the list of verified winners in step 2035, and the winner counter is increased. Ultimately, TPR contacts Mike in step 2010 to verify his CR\overline{A}V ID, registration information, and response information in step 2020. Mike's registration information was falsified (he said he was 60 when registering, but in reality he is 25), so he is disqualified, because truthful answers are required as a condition of winning according to ABS Promotion rules. All of Mike's data is also purged from the Data Storage Center 195 to avoid potentially false or misleading information. This is done to maintain data base integrity. According to step 2020, because Mike's information is not correct, the first alternate winner at the top of the list is chosen, as set forth in step 2025. Mrs. Daly is the first alternate winner, so her information is verified in step 2025. Because Mrs. Daly's immersion verification question was correct, and her demographic data is proven to be accurate and verified in step 2031, so she is selected as a verified winner and added to the list in step 2032.

In step 2035, once all 50 winners have been selected and verified, the process moves to step 2040, where TPR forwards to ABS the information as to the identities of all winners, including Mrs. Daly. In step 2040, ABS and ACME also jointly announce the name of all winners, including Mrs. Daly. Included in the information passed to ABS from TPR in step 2040 is a report including demographic information for all Consumer responses for the ACME and pollster designed questions, which ABS may elect to pass along to ACME or to survey organizations who have contracted ABS to acquire polling statistics. This report is derived and data mined from the registration and response data. This information includes statistics indicating that of the 5.532 million female Consumers 110, 534,461 live in households with average incomes in excess of $75,000 per year. This information also indicates that, of these, 6.5% live in the state of Florida and are over 50 years old, and 3.443% expect to purchase a car within the next six months, 5.2% live in the metropolitan NYC area, and 0.8429% expect to purchase a new car within the next six months. The statistics also indicate that across all age groups, and all occupations, Frank Maggio will be elected President in 2008 by a 59.8% share of the popular vote.

In step 2045, TPR forwards a convertible to Mrs. Daly and the other winners. The process ends in step 2099.

Other Applications

While the above description is ideally suited for visual mass media broadcast technology such as the Broadcast TV 120, Cable TV 135, Satellite TV 140, Private Networks 125, Other Networks 141, and the Internet 130, it may also be utilized in alternate mass media channels, using audio-only technology like radio, or visual-only broadcast mediums, such as a magazine or newspaper ad. The CR\overline{A}V Ads may be answered with complicated, highly developed computer Devices 111, or simply by using the Phone 145. Those practiced in the art will recognize the above invention may be implemented with any broadcast medium and response medium. In addition, the invention is not limited to providing ads with entertainment content, but can be extended to providing other types of information.

Printed Response Devices

As mentioned above, in an exemplary embodiment, the Other Response Device 166 can comprise a printed response device, which can be delivered subsequently to the data storage center 195. Printed response devices can provide a cost-effective means of interacting and can rely upon an information gathering system 191, such as the U.S. Postal service network or Private Delivery services (ranging from couriers to overnight mail service center networks), to deliver the printed responses to the data storage center 195. Additionally, printed responses can be forwarded to the data storage center 195 via a facsimile machine, or can be scanned and forwarded via e-mail or other computer media.

In an exemplary embodiment, Consumers (recipients) can interact with CR\overline{A}V ads through printed responses, which can be forwarded subsequently to a data storage center 195 for compilation utilizing manual methodologies. Other compilation methodologies may be employed such as Optical Character Recognition (OCR) or Optical Mark Recognition (OMR), which will facilitate a quicker and more efficient compilation of data contained on the printed responses when compared to manual data entry.

In one embodiment of a CR\overline{A}V printed response, other elements of a CR\overline{A}V ad can be included on the printed response device itself, in effect converting the printed response to a self-contained, printed CR\overline{A}V ad, complete with the “Alert,” printed “Vignette,” and Immersion Verification Query (or an area upon the printed response to enter the response, after broadcast of the Immersion Verification Query via another medium, such as Television or Internet).

Production and Distribution of CR\overline{A}V Printed Responses

The means by which the Consumer may obtain a printed response may include, but are not limited to, newspaper (local or national) printed responses printed as content on the pages or as a separate insert; magazine (local or national) printed responses printed as content on the pages or as a separate insert; e-mail delivery to registered CR\overline{A}V players that have elected this service; Internet download from the CR\overline{A}V promoter, Advertiser, or affiliated site, in .pdf, .txt, .doc, or other format; direct mail (either upon request or as part of a direct mail promotion); physical distribution points, such as grocery stores, gas stations, or other affiliated establishments; and facsimile delivery to registered CR\overline{A}V players who have elected this service, or to those who have requested a facsimile printed response.

OCR and OMR Technology

OCR (Optical Character Recognition) involves electronic reading of text from paper and translating the images into a form that the computer can manipulate. An OCR system enables feeding a document directly into an electronic computer file. The text can be written in any method acceptable to the OCR system. For example, the text can be written with a dark pencil or ink and in a legible manner. Any difficulties the computer develops when identifying a character may involve manual intervention. While this method does require more manual intervention than OMR, discussed below, it is significantly quicker than pure manual entry for all data to be captured.

OMR (Optical Mark Reading) is a process to detect the presence of intended, marked responses. An OMR form comprises response areas (“bubbles”), which a consumer marks to indicate a response. A mark, such as a darkened bubble, registers significantly less light than the surrounding paper. In order to be detected, a mark should be positioned correctly on the paper (within the bubble) and significantly darker than the surrounding paper. While being the most accurate and quickest method of capturing data, OMR forms are larger than OCR forms due to the included bubbles.

Sample CR\overline{A}V Printed Responses

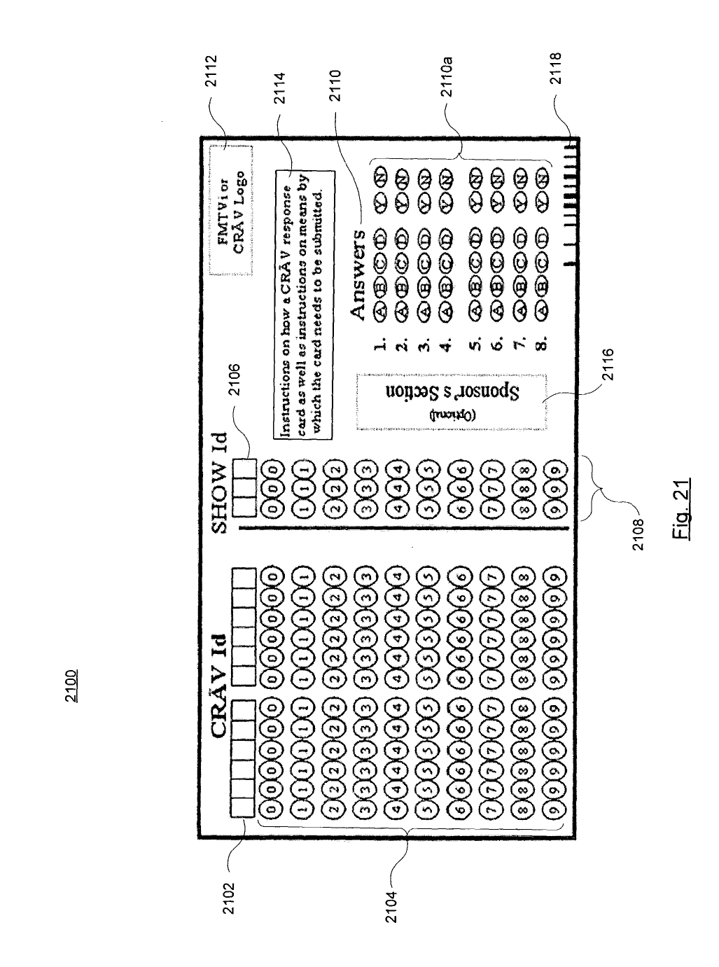

FIGS. 21-24 illustrate representative printed responses according to exemplary embodiments of the present invention. FIG. 21 illustrates a representative OMR printed response 2100 according to an exemplary embodiment of the present invention. As shown in FIG. 21, the printed response 2100 comprises CR\overline{A}V identification number blocks 2102 and corresponding OMR bubbles 2104. Accordingly, a registered recipient can enter his CR\overline{A}V identification number in the blocks 2102 and can darken the corresponding bubbles in the bubbles 2104.

The printed response 2100 also comprises show identification number blocks 2106 and corresponding OMR bubbles 2108. The recipient can enter the show identification number in the blocks 2106 for the particular show in which the recipient reviewed the CR\overline{A}V advertisement and can darken the corresponding bubbles 2108. The printed response 2100 can be used for multiple CR\overline{A}V-enabled shows by allowing the recipient to enter in blocks 2106 the particular show identification number for which the recipient is responding to the query. Accordingly, the printed response 2100 can provide greater flexibility and longevity for distribution channels, such as physical distribution points.

An answer section 2110 comprises OMR bubbles 2110a for each Query. In the exemplary embodiment of FIG. 21, the answer section 2110 includes OMR bubbles 2110a for eight Queries. To answer a Query about a Vignette, the recipient darkens one of the OMR bubbles 2110a corresponding to the answer choice for a particular Query. As illustrated in FIG. 21, the OMR bubbles 2110a can comprise four multiple choice answers A-D, as well as a yes/no answer choice for each Query. The yes/no answer choices can allow a recipient to answer an optional advertiser fulfillment question for each Query.

The printed response 2100 also can comprise an alert 2112 to indicate that the recipient can receive substantial awards by answering a question about a corresponding broadcast advertisement. In an exemplary embodiment, the alert 2112 can comprise the FMTVi or CR\overline{A}V logo. In an alternative exemplary embodiment, the alert 2112 can provide additional information to inform the consumer to watch a particular televised CR\overline{A}V ad or ad pod comprising the Vignette and/or Query. An advertisement pod comprises multiple advertisements, at least one of which comprises a CR\overline{A}V advertisement. The multiple advertisements of an advertisement pod can be presented together in a group, individually at different times, or as a combination of individual and group advertisements.

An instruction section 2114 informs the recipient how to complete and submit the printed response 2100 to qualify for the substantial rewards. For example, submission instructions can include a postal address or facsimile phone number. In an alternative embodiment, the instructions can be provided separately from the printed response 2100. For example, the instructions can be provided in the corresponding advertisement, a separate advertisement, a website, or other location.

In a sponsor's section 2116, advertising space can be sold to a sponsor to produce revenues that offset printing and distribution costs of the printed response 2100. A return address (not shown) can be provided on the back of the printed response 2100. The return address can inform the recipient of the address for submitting the printed response 2100. A bar code 2118 provides a registration mark for the OCR and OMR scanning equipment.

In operation, a recipient completes and submits the printed response 2100. An OMR reader detects the blackened bubbles in sections 2104, 2108, and 2110a to verify immersion by determining whether the recipient correctly answered the Query.

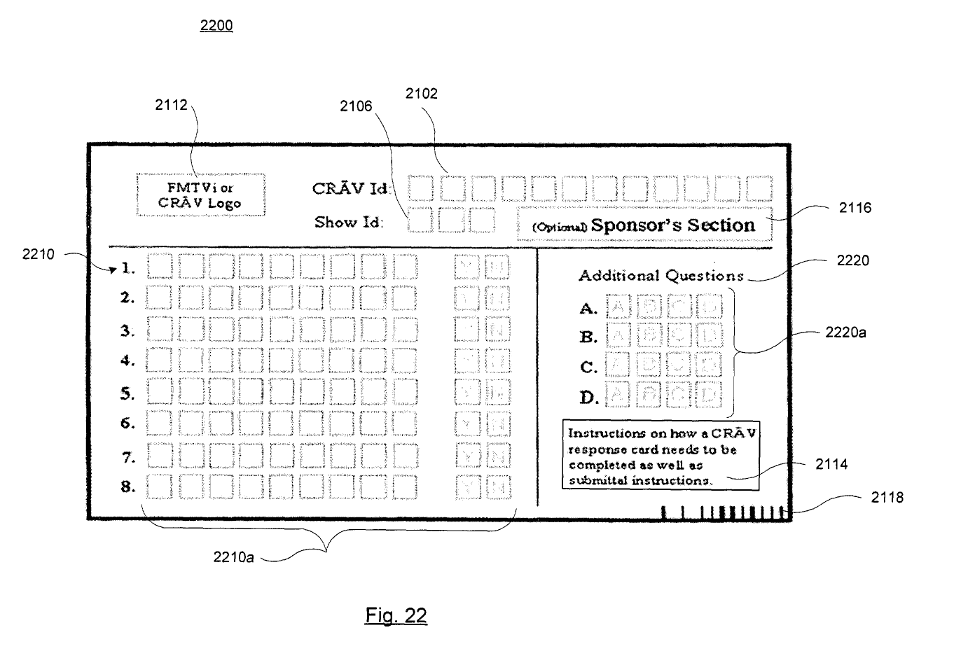

FIG. 22 illustrates a representative OCR printed response 2200 according to an exemplary embodiment of the present invention. As shown in FIG. 22, the printed response 2200 comprises the CR\overline{A}V identification number blocks 2102 and the show identification number blocks 2106. However, because an OCR reader can detect the written characters in the blocks 2102 and 2106, corresponding OMR bubbles are not provided.

An answer section 2210 provides answer blocks 2210a in which a recipient can enter the response to the Query. With the OCR printed response 2200, a recipient's answers are not confined to multiple choice. Accordingly, a recipient can enter any characters in the answer blocks 2210a. Additionally, as shown, a recipient can answer an optional yes/no advertiser fulfillment question for each Query in the corresponding Y/N blocks.

In the exemplary embodiment illustrated in FIG. 22, an additional questions section 2220 allows a recipient to respond to additional questions asked by an advertiser. As shown, the additional questions section 2220 comprises answer blocks 2220a in which the recipient can enter a response to each of several additional questions. As illustrated, the additional question answer blocks 2220a can present a multiple-choice answer selection in an undetectable color to indicate the expected character for the recipient to enter.

In operation, a recipient completes and submits the printed response 2200, and an OCR reader detects the characters in blocks 2102, 2106, 2210a, and 2220a to verify immersion by determining whether the recipient correctly answered the Query.

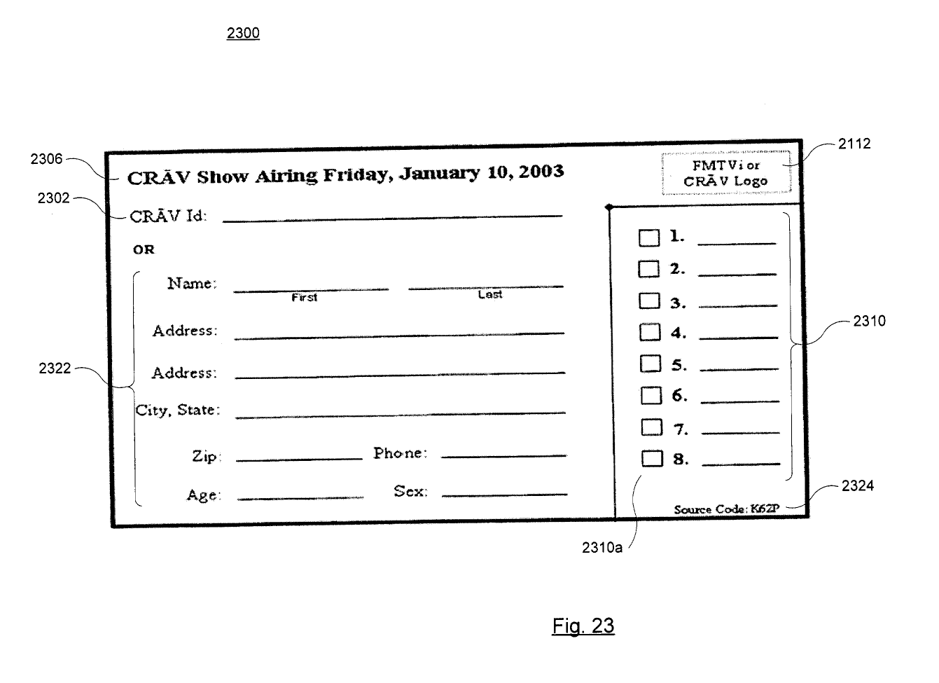

FIG. 23 illustrates a representative manual data entry printed response 2300 according to an exemplary embodiment of the present invention. The manual data entry printed response 2300 does not require any special paper stock and can be printed easily on newsprint, magazine, or other stock. As illustrated in FIG. 23, the printed response 2300 comprises a CR\overline{A}V identification section 2302, a registration section 2322, and an answer section 2310. Each section 2302, 2322, and 2310 allows a recipient to write in all data in the blanks provided. The registration section 2322 allows a recipient to register at the time the recipient submits the answers to the query. Alternatively, the recipient can enter a pre-registered CR\overline{A}V identification number in the section 2302. In the answer section 2310, a recipient writes answers in the blanks corresponding to the respective Query. Additionally, the recipient can check a fulfillment box 2310a provided next to each Query number to indicate that the recipient has provided an answer for that query.

The printed response 2300 also comprises a predetermined show identification section 2306 to indicate the particular show for which the printed response 2300 applies. Accordingly, the printed response 2300 can be used for only the particular show identified in section 2306, thereby providing a one time, one-game use printed response.

A source code 2324 provides information regarding the location where the recipient obtained the printed response 2300.

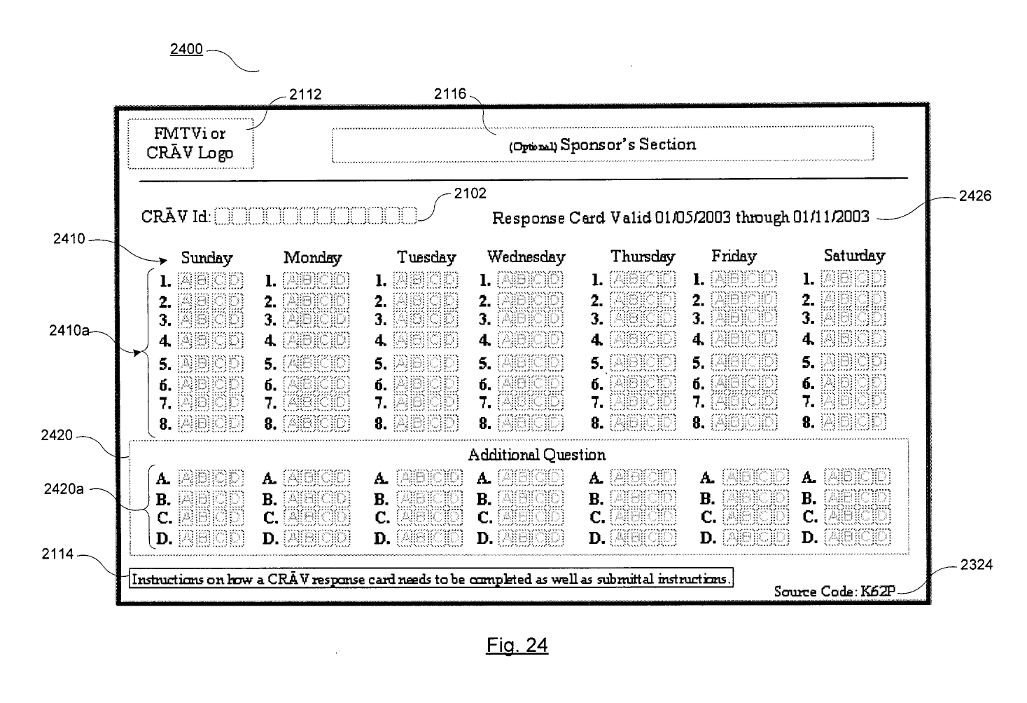

FIG. 24 illustrates a representative multiple-entry printed response 2400 according to an exemplary embodiment of the present invention. As illustrated in FIG. 24, the printed response 2400 comprises a weekly printed response having daily answer sections 2410 for an entire week of scheduled CR\overline{A}V advertisements. Each daily answer section 2410 comprises answer blocks 2410a in which a recipient can enter a response to multiple Queries for advertisements broadcast during the respective day. The exemplary printed response 2400 comprises OCR answer blocks 2410a. In an alternative embodiment, the printed response 2400 can comprise OMR answer blocks. The printed response 2400 also comprises an additional questions section 2420 comprising additional daily question blocks 2420a for each respective day of the week.

A validity field 2426 indicates the effective date of the printed response 2400. The printed response 2400 can allow multiple days of CR\overline{A}V ads to be verified on a single printed response. The weekly printed response 2400 illustrated in FIG. 24 can be distributed once a week, or smaller printed responses could be distributed daily. In an exemplary embodiment, weekly and daily printed responses can be delivered to the recipients via national or local newspapers, or other print media.

The exemplary printed responses illustrated in FIGS. 21-24 are not limited to the specific features discussed above. Other features can be added to the printed responses within the scope of the present invention. Additionally, combining features from different printed responses discussed above is within the scope of the present invention.

Delivery of Printed Response to the Data Center

All versions of the printed response, regardless of the type of process used to process the data, can be transmitted or mailed to recipients utilizing a private or public delivery network, such as the United States Postal Service. Versions of the printed response that will be processed manually also can be transmitted by facsimile to the recipients.

The recipients can return the printed responses by mail, facsimile transmission, or other electronic methods to the data storage center 195. The data storage center 195 receives mailed printed responses and processes them manually or through OCR/OMR to capture the data on each printed response. The data storage center 195 can print printed responses received by facsimile transmission and can process the printed responses in a similar manner. Additionally, if the data storage center 195 captures the faxed printed response via facsimile server, then data input personnel can view the faxed printed response on a screen to process the data, thereby alleviating the need to print the faxed printed response.

In exemplary embodiments, recipients can utilize other methods to return the printed responses to the data storage center 195. For example, the recipients can hand deliver the printed responses (personally or via courier), as well as deliver the printed responses by overnight or priority delivery. The allowed methods of delivery depend on the Promoter, who can establish the particular methods acceptable for each response based on volume processing needs.

Combined CR\overline{A}V Ad and Printed Response

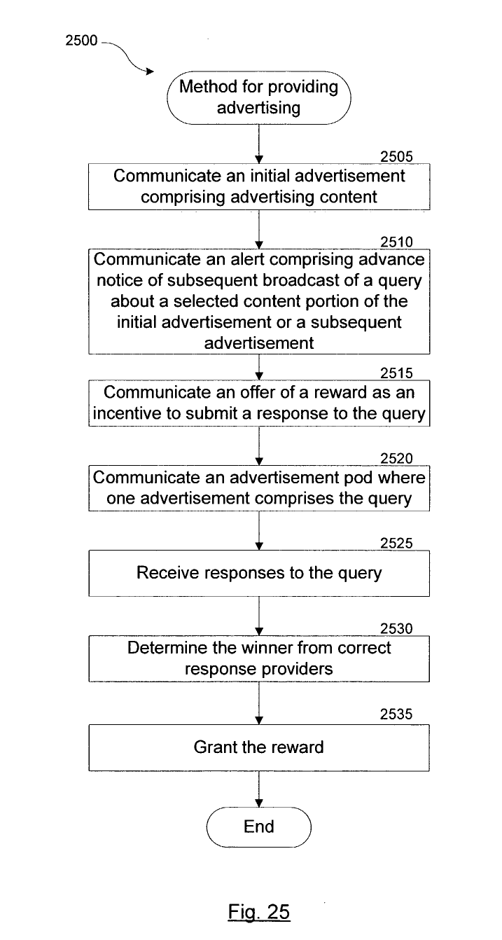

In an exemplary embodiment, a CR\overline{A}V printed response can combine elements of a CR\overline{A}V ad itself. When those elements are combined with the written interactive portion of the reply, the printed response can serve as a self-contained CR\overline{A}V promotion. Such a combination will be described with reference to FIG. 25.

FIG. 25 is a flow chart depicting a method 2500 for providing advertising that combines CR\overline{A}V ad elements with the interactive portion of a reply according to an exemplary embodiment of the present invention. In step 2505, the Promoter communicates an initial advertisement to multiple recipients via a mass media, non-interactive broadcast network. The initial advertisement comprises advertising content for a promotion and is communicated prior to subsequent advertisements related to the initial advertisement. In step 2510, the Promoter communicates an Alert that provides advance notice of subsequent broadcast of a Query about a selected content portion of the initial advertisement. The Alert can provide notice that the Query will be presented during one of multiple advertisements broadcast at a subsequent time. In an exemplary embodiment, the Alert can be communicated in the initial advertisement. In an alternative exemplary embodiment, the Alert can be communicated separately from the initial advertisement.

In step 2515, the Promoter communicates an offer of a reward as an incentive for the recipients to submit a response to the query. Accordingly, the offer can provide an incentive for the recipients to become exposed to the subsequent broadcast of the Query to be able to submit a response.

In step 2520, the Promoter communicates an advertisement pod to multiple recipients via a mass media, non-interactive broadcast network. The advertisement pod comprises multiple advertisements, at least one of which comprises a CR\overline{A}V advertisement. One of the multiple advertisements can comprise the Query, as indicated in the Alert. The recipients then respond to the Query, and the data storage center 195 receives the responses in step 2525. In step 2530, the data storage center 195 processes the responses and determines one or more winners of the reward, based on correct responses to the Query. Finally, in step 2535, the Promoter grants the reward to each winner.

In an exemplary embodiment, the initial advertisement can be communicated on or with a printed response. Accordingly, the recipients can respond to the Query by indicating their response on the printed response and forwarding the printed response to the data storage center 195 for processing.

For example, HammerTime Hardware store publishes a printed advertisement in a national newspaper, such as USA Today. In the advertisement, HammerTime prints the CR\overline{A}V logo (qualifying as an Alert), and utilizes the advertisement's content portion of the promotion to educate the recipients about several new benefits of HammerTime's newly renovated stores. Among the benefits described is the “3 or Free” promotion, under which a Consumer waiting more than 3 minutes in a checkout line at HammerTime receives one item free.

The Alert also can inform the recipient that a Query about a selected content portion of HammerTime's newspaper advertisement will be broadcast subsequently on the CRS TV network during a televised CR\overline{A}V advertisement pod airing Monday evening during the 8:00 PM program hour. The advertisement also can comprise an offer of a reward by indicating that HammerTime will award fifty 24k gold hammers to recipients that respond correctly to the Query. That offer can serve as a clue that the CR\overline{A}V ad within the advertisement pod will be an advertisement by HammerTime Hardware.

The newspaper advertisement further can comprise a printed response section to be completed by the recipient. The printed response can comprise an area for insertion of a CR\overline{A}V ID number, or a section to register, an answer area to darken bubbles for A, B, C, D responses to the Query, and a yes/no question asking if the Consumer wants to receive a $10 coupon redeemable at the nearest HammerTime Hardware store.

Such a CR\overline{A}V advertisement, combined with a printed response, might appear as a typical printed advertisement, with an Alert logo on the page or printed response, and comprising a printed response similar to one of the exemplary printed responses illustrated in FIGS. 21-24. In this example, the Immersion Verification Query will be distributed via network television, and the advertisement or printed response comprises the Alert and Vignette elements of a CR\overline{A}V advertisement.

The CRS network broadcasts a plurality of ads, including a HammerTime ad, on CRS during the 8:00 PM Monday evening hour. The CRS network also broadcasts the Immersion Verification Query, “How many minutes will you wait before one item you are buying is free?” The Query can be correctly answered by immersion in either the newspaper or TV HammerTime advertisement. The recipient views the plurality of ads and the Query and selects one of the answer choices a) 1, b) 2, c) 3, and d) 5 minutes on the printed response. The recipient can darken the “c” bubble, enter their CR\overline{A}V ID number, and mail the clipped printed response to the instructed address to qualify for substantial rewards. The recipient may choose to receive a free $10 coupon as well.

Additional Considerations for Printed Responses

Printed responses have several benefits when compared to live, immediate responses delivered via the Internet or telephone. The greatest benefit of printed responses is the ease of distribution (via most publishing methodologies, or via direct mail), and the simple nature of interaction that is available to virtually everyone who can read. However, the deferred time between submission of a response by a recipient and receipt by the Promoter allows for the Consumer to potentially research the CR\overline{A}V advertisement before submitting a response, which potentially can lessen the quality of Immersion. For example, a recipient could tape a program containing CR\overline{A}V ads and could simply rewind to the portion of the CR\overline{A}V advertisement that presents the Immersion Verification Query. Then, the recipient could seek out only that element of the advertisement that comprises the Query and could avoid the remainder of the advertisement. Alternatively, the recipient could pay less attention to some portions while focusing only on the topic subject to the query (in our example, the number of wait minutes.) The Consumer might not need to memorize an advertisement to be better able to successfully verify Immersion. On the other hand, the deferred player may be afforded the time to tape and replay the advertisements multiple times, which provides for repeat exposure of the advertisements to the Consumer.

If a Promoter believes that memorization is a key element for obtaining Immersion, and that delayed verification (say, by printed response, or via Internet after a predetermined time frame has elapsed) is not desirable, then the Promoter can provide differing levels of awards based on the type of Interaction. For instance, in the above example, the Promoter can announce that forty of the fifty gold hammers will be awarded to recipients that respond within sixty seconds of the broadcast advertisement pod. The balance of ten hammers will be awarded to recipients that successfully respond within forty-eight hours (or other time frame) of the advertisement pod broadcast. That prizing structure rewards live interaction and memorization more while allowing slower methods of response.

Additionally, the deferred response prizing structure can apply to a deferred response from any response device. For example, a recipient that responds within sixty seconds, or any predetermined time frame, can qualify for a specified reward or reward pool. The recipient can respond within the time frame by any response device. For example, the recipient can respond within the time frame by telephone, Internet, faxed printed response, or other response device. The recipient can qualify for a different level of reward or reward pool by responding after the initial time frame and before the closing of the response period. Again, the recipient can respond by any response device to qualify for the different reward level. For example, the recipient can respond within the time frame by telephone, Internet, faxed printed response, mailed printed response, or other response device.

The Promoter also can determine whether to distribute long-term printed responses (such as the weekly printed response 2400 of FIG. 24), daily printed responses, or single use printed responses (as in the HammerTime example above). An entire week of scheduled CR\overline{A}V ads could be verified on a single printed response distributed once a week (for example, in a national newspaper). Alternatively, daily or single-use printed responses could be distributed daily in a local newspaper and can allow interaction with Consumers that missed the weekly printed response distribution. Additionally, the weekly printed response also could be distributed every day in a daily publication, which might increase advertisement size and corresponding advertisement cost to the Promoter. Weekly printed responses potentially can provide savings to recipients in postage when compared to daily or single use printed responses, especially when drop-off locations are not convenient or when printed responses do not have prepaid postage.

Promoters also can consider the cost of collecting data submitted on printed responses, particularly data submitted on printed responses printed in publications having paper stock that is not suitable for OCR and OMR machines (such as newsprint). Printed responses may be submitted via postal delivery and may be folded and inserted into an envelope, potentially requiring the fulfillment and verification process to include opening of envelopes and manual data entry (both of which add to promotional costs). Promoters may avoid some of those costs with weekly printed responses to reduce envelope opening to once a week.

Additional data collected during a CR\overline{A}V advertisement (such as polling information) is obtained more cost-effectively when the additional queries are presented during the response process, as opposed to during the more expensive broadcast for which the Promoter must purchase additional air time. To provide interaction to these additional queries on a printed response, the Promoter can include the queries on the printed response.

A weekly printed response may provide areas for response interaction for nine advertisements per day, for seven days, totaling sixty-three response areas. To make a CR\overline{A}V pod of four advertisements more effective, the Promoter wants recipients to pay attention to all four advertisements even if only one advertisement in the pod comprises an actual CR\overline{A}V advertisement. Such a level of attention can provide all advertisers with high levels of Immersion. Accordingly, the Promoter can structure the printed response to prevent the printed response from providing a clue to the particular CR\overline{A}V advertisement within the pod. For instance, in the HammerTime example discussed above, the Promoter attempts to avoid indicating that the second question of the third pod on Monday will be sponsored by HammerTime Hardware. Therefore, in some cases, the Promoter may not provide non-Immersion Verification queries, or related query interaction areas, on a printed response, to avoid providing clues that potentially impact other advertisements in a pod negatively.

In such an instance, where only Immersion Verification responses and ID information are provided on a mailed-in or delivered printed response, the Promoter can ask the recipient to place his CR\overline{A}V ID number on the face of the envelope. Then, the Promoter may elect to draw envelopes at random to award prizes, thereby avoiding opening and data entry costs for all non-winning printed response submissions. That process works best when the Promoter sees little or no value in the non-Immersion Verification responses (such as polling responses). Alternatively, the Promoter can have the CR\overline{A}V ID numbers manually entered from the envelope fronts, if the Promoter deems that information to be valuable. The Promoter also can ask the recipient to place on the envelope's outside the number of CR\overline{A}V advertisements to which the Consumer is responding (e.g., 27 of 63 advertisements were viewed in a week). The Promoter may value that data, which can be entered without incurring the costs of opening all envelopes and entering all data.

Although specific embodiments of the present invention have been described above in detail, the description is merely for purposes of illustration. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

What is claimed is:

1. A method for providing advertising, comprising the steps of:
communicating through a mass media, non-interactive broadcast network an advertisement pod comprising a plurality of advertisements to a plurality of recipients, the plurality of advertisements comprising advertising content for each advertisement;
communicating a query about a selected portion of the advertising content of at least one of the advertisements;
presenting an offer of a reward as an incentive for each recipient to review the advertisements and to submit the response to the query; and
collecting, through a printed response, the respective response to the query from each of responding ones of the recipients,
wherein receipt of each response having a correct reply to the query verifies that the responding recipient has been exposed to at least the selected portion of the advertising content.

2. The method of claim 1, wherein the step of communicating the advertisements to the recipients comprises transmitting the advertisements through a plurality of mass media, non-interactive broadcast networks for delivery to the recipients.

3. The method of claim 1, further comprising the step of granting the reward to at least one of the recipients submitting the response to the query, wherein the reward grant is provided at a time subsequent to communication of the advertisements based upon confirmation of a correct reply to the query.

4. The method of claim 1, wherein the collecting step comprises receiving the printed response through at least one of a mail carrier system and a facsimile transmission.

5. The method of claim 1, wherein the collecting step comprises collecting, through the printed response and through at least one other medium other than the mass-media, non-interactive broadcast network, the respective response to the query from each of responding ones of the recipients.

6. The method of claim 5, wherein a response collected through a printed response and a response collected through another media other than the mass-media, non-interactive broadcast network receive a different level of the reward.

7. The method of claim 1, wherein the mass-media, non-interactive broadcast network comprises at least one of newspaper, magazine, and e-mail, and
further comprising the step of providing the printed response to recipients in the mass-media, non-interactive broadcast network.

8. The method of claim 1, further comprising the step of communicating, through at least one of newspaper, magazine, and e-mail, the printed response to at least one of the recipients.

9. The method of claim 1, wherein the printed response comprises one of an OMR printed response, an OCR printed response, and a manual data entry printed response.

10. The method of claim 9, wherein the printed response comprises a plurality of answer blocks for collecting answers to each query associated with a plurality of advertisement pods.

11. The method of claim 9, wherein the query comprises an immersion verification question and at least one additional question, and
wherein the printed response comprises answer blocks for each question in the query.

12. The method of claim 1, further comprising the step of communicating an alert providing advance notice of subsequent broadcast of the advertisements.

13. The method of claim 12, wherein the step of communicating an alert comprises presenting the alert on the printed response.

14. The method of claim 12, wherein presentation of the alert to the recipients is separate from presentation of the selected portion of the advertising content to the recipients.

15. The method of claim 12, wherein the alert is presented to the recipients at a first time and the selected portion of the advertising content is presented to the recipients at a second time, and wherein the first time is different from the second time.

16. The method of claim 12, wherein presentation of the alert to the recipients is accomplished via a first communications media and presentation of the advertisements is accomplished via a second communications media, the first communications media being different from the second communications media.

17. The method of claim 1, further comprising the step of collecting registration information from the recipients to register for the opportunity to respond to the query.

18. The method of claim 17, wherein the step of collecting registration information comprises receiving the registration information on the printed response.

19. The method of claim 1, wherein the steps of communicating the advertisements to the recipients and communicating the query comprise:
broadcasting an advertisement comprising a vignette including the selected portion of the advertising content; and
broadcasting an advertisement comprising the query.

20. The method of claim 19, wherein the step of communicating the advertisements further comprises broadcasting an advertisement comprising an alert for providing the recipients with advance notice that the vignette is scheduled for subsequent delivery to the recipients.

21. The method of claim 20, wherein the step of communicating the advertisements further comprises broadcasting a Sneak Peek vignette for communicating to the recipients the vignette or other content to assist the recipients in answering the query, wherein the Sneak Peek vignette is communicated to the recipients in advance of the alert.

22. The method of claim 1, wherein the collecting step comprises delivering the printed response from the recipient to a data storage center operable to collect and process each response.

23. A system for providing advertising, comprising:
a mass media, non-interactive broadcast network operable to communicate an advertisement pod comprising a plurality of advertisements to a mass audience comprising a plurality of recipients, the plurality of advertisements comprising advertising content for each advertisement;
a query communications media operable to communicate a query about a selected portion of the advertising content of at least one of the advertisements;
a reward communications media operable to communicate to the mass audience an offer of a reward as an incentive to submit a response to the query;
a plurality of response devices at least one of which comprises a printed response, each response device operable by one of the recipients of the advertisements to communicate, through a medium other than the mass-media, non-interactive broadcast network, a respective response to the query; and
an information gathering system operable to collect each response to the query communicated by the response devices,
wherein receipt of each response having a correct reply to the query verifies that the responding recipient has been exposed to at least the selected portion of the advertising content, and
wherein a grant of the reward is provided at a time subsequent to communication of the advertisements to at least one of the responding recipients based upon confirmation of the correct reply to the query.

24. The system of claim 23, further comprising a plurality of the mass-media, non-interactive broadcast networks, each operable to communicate the advertisements to the mass audience.

25. The system of claim 24, wherein each of the broadcast networks is operable to communicate the advertisements simultaneously for receipt by the mass audience.

26. The system of claim 24, wherein the plurality of broadcast networks comprises one or more of cable, satellite, streaming Internet, and private networks.

27. The system of claim 23, wherein the information gathering system receives the printed response from one of a mail carrier system and a facsimile machine.

28. The system of claim 23, wherein the mass-media, non-interactive broadcast network comprises at least one of newspaper, magazine, and e-mail, and
wherein the broadcast network is further operable to communicate the printed response to the mass audience.

29. The system of claim 23, wherein the printed response comprises one of an OMR printed response, an OCR printed response, and a manual data entry printed response.

30. The system of claim 29, wherein the printed response comprises a plurality of answer blocks for collecting answers to a plurality of advertisement pods.

31. The system of claim 29, wherein the query comprises an immersion verification question and at least one additional question, and
wherein the printed response comprises answer blocks for each question in the query.

32. The system of claim 24, wherein the printed response comprises an alert providing advance notice of subsequent broadcast of the advertisements.

33. The system of claim 32, wherein presentation of the printed response to the recipients is separate from presentation of the selected portion of the advertising content to the recipients.

34. The system of claim 32, wherein presentation of the alert to the recipients is separate from presentation of the selected portion of the advertising content to the recipients.

35. The system of claim 23, wherein the information gathering system is further operable to collect registration information from the mass audience to register for the opportunity to respond to the query.

36. The system of claim 35, wherein the printed response comprises the registration information collected by the information gathering system.

37. A method for providing advertising, comprising the steps of:
communicating through a first mass media, non-interactive broadcast network an initial advertisement to a plurality of recipients, the initial advertisement comprising advertising content;
communicating through a second mass media, non-interactive broadcast network an advertisement pod comprising a plurality of advertisements each comprising advertising content, at least one of the plurality of advertisements comprising a query about a selected portion of the advertising content of one of the initial advertisement and a one of the plurality of advertisements;
presenting an offer of a reward as an incentive for each recipient to become exposed to one of the initial advertisement and the plurality of advertisements and to submit a response to the query; and
collecting the respective response to the query from each of responding ones of the recipients,
wherein receipt of each response having a correct reply to the query verifies that the responding recipient has been exposed to at least the selected portion of the advertising content.

38. The method of claim 37, wherein the first broadcast network is different from the second broadcast network.

39. The method of claim 37, wherein the steps of communicating comprise transmitting each of the initial advertisement and the advertisement pod through a plurality of mass media, non-interactive broadcast networks for delivery to the recipients.

40. The method of claim 37, further comprising the step of granting the reward to at least one of the recipients submitting the response to the query, wherein the reward is provided at a time subsequent to communication of the advertisements based upon confirmation of a correct reply to the query.

41. The method of claim 37, wherein a response collected within a predetermined time frame of the query broadcast qualifies for a different reward level than a response collected after the predetermined time frame.

42. The method of claim 37, wherein the collecting step comprises receiving a printed response comprising the response to the query.

43. The method of claim 42, wherein the collecting step comprises receiving the printed response through at least one of a mail carrier system and a facsimile transmission.

44. The method of claim 42, wherein the collecting step comprises collecting, through the printed response and through at least one other medium other than the mass-media, non-interactive broadcast network, the respective response to the query from each of responding ones of the recipients.

45. The method of claim 44, wherein a response collected through a printed response and a response collected through a medium other than the mass-media, non-interactive broadcast network receive a different level of reward.

46. The method of claim 42, wherein the mass-media, non-interactive broadcast network comprises at least one of newspaper, magazine, and e-mail, and
further comprising the step of providing the printed response to recipients through the first mass-media, non-interactive broadcast network.

47. The method of claim 42, further comprising the step of communicating, through at least one of newspaper, magazine, and e-mail, the printed response to at least one of the recipients.

48. The method of claim 42, wherein the printed response comprises one of an OMR printed response, an OCR printed response, and a manual data entry printed response.

49. The method of claim 48, wherein the query comprises an immersion verification question and at least one additional question, and
wherein the printed response comprises answer blocks for each question in the query.

50. The method of claim 42, wherein the step of communicating the initial advertisement comprises communicating an alert providing advance notice of subsequent broadcast of the query.

51. The method of claim 50, wherein the step of communicating an alert comprises presenting the alert on the printed response.

52. The method of claim 50, wherein presentation of the alert to the recipients is separate from presentation of the query to the recipients.

53. The method of claim 42, wherein presentation of the selected portion of the advertising content to the recipients is accomplished via a first communications media and presentation of the query is accomplished via a second communications media, the first communications media being different from the second communications media.

54. A method for providing advertising, comprising the steps of:
communicating through at least one of newspaper, magazine, and e-mail an advertisement to a plurality of recipients, the advertisement comprising advertising content, a query about a selected portion of the advertising content, a printed response device for responding to the query, and an offer of a reward as an incentive for each recipient to become exposed to the advertisement and to submit a response to the query; and
collecting the respective response to the query from each of responding ones of the recipients by collecting the respective printed response device,
wherein receipt of each response having a correct reply to the query verifies that the responding recipient has been exposed to at least the selected portion of the advertising content.

55. The method of claim 54, further comprising the step of granting the reward to at least one of the recipients submitting the response to the query, wherein the reward is provided at a time subsequent to communication of the advertisements based upon confirmation of a correct reply to the query.

56. The method of claim 54, wherein the collecting step comprises receiving the printed response device through at least one of a mail carrier system and a facsimile transmission.

57. The method of claim 54, wherein the collecting step comprises collecting, through the printed response device and through at least one other medium other than newspaper, magazine, and e-mail, the respective response to the query from each of responding ones of the recipients.

58. The method of claim 57, wherein a response collected through a printed response device and a response collected through a medium other than newspaper, magazine, and e-mail receive a different level of reward.

59. The method of claim 54, wherein the printed response device comprises one of an OMR printed response, an OCR printed response, and a manual data entry printed response.
